(19) United States
(12) Patent Application Publication
(10) Pub. No.: US 2020/0111108 A1
(43) Pub. Date: Apr. 9, 2020

(54) INFORMATION PROCESSING SYSTEM, INFORMATION PROCESSING METHOD AND NON-TRANSITORY COMPUTER-READABLE MEDIUM FOR EXECUTING THE METHOD

(71) Applicants: Masahiko ITOH, Kanagawa (JP); Tsutomu KAWASE, Kanagawa (JP)

(72) Inventors: Masahiko ITOH, Kanagawa (JP); Tsutomu KAWASE, Kanagawa (JP)

(73) Assignee: Ricoh Company, Ltd., Tokyo (JP)

(21) Appl. No.: 16/707,266

(22) Filed: Dec. 9, 2019

Related U.S. Application Data
(62) Division of application No. 15/150,541, filed on May 10, 2016.

(30) Foreign Application Priority Data
May 19, 2015 (JP) 2015-102106

(51) Int. Cl. G06Q 30/02; G07G 1/00; G06Q 20/20; G07G 1/14

(52) U.S. Cl. CPC G06Q 30/0201; G07G 1/14; G06Q 20/202; G07G 1/009

(57) ABSTRACT

An information processing system includes a sound wave transmitting device, a terminal device and an information processing device. The sound wave transmitting device controls the sound wave transmitting device to identify itself by outputting identification information of the sound wave transmitting device. The terminal device receives the identification information, stores the identification information along with a receiving time, controls to display a predetermined code information based on a determination whether the terminal device receives an operation for displaying the predetermined code information corresponding to product identification information of a product, and transmits, to the information processing device, identification information of a sound wave identification device and time information of receiving the identification information of the sound wave identification device along with the product identification information corresponding to a displayed predetermined code information. The information processing device stores the identification information, the time information and the product identification information.

### CROSS-REFERENCE TO RELATED APPLICATION

This application is a divisional patent application of, and claims the benefit of and priority to, U.S. patent application Ser. No. 15/150,541 filed on May 10, 2016, which is based on and claims priority to Japanese Priority Patent Application No. 2015-102106, filed on May 19, 2015, the entire contents of which are hereby incorporated herein by reference.

### BACKGROUND OF THE INVENTION

### 1. Field of the Invention

The present invention relates to an information processing system, an information processing method and non-transitory computer-readable medium for executing the method.

### 2. Description of the Related Art

Systems for analyzing consumption trends of customers in stores, etc., are known.

For example, there is known a consumer behavior analysis device for analyzing the consumption trends of consumers by combining flow line analysis and image analysis, with the use of an RFID tag storing the ID of a shopping cart, an RFID reader capable of communicating with the RFID tag, and an imaging device.

The existing POS (Point Of Sales) system (predetermined aggregation system) is often installed in stores, etc., and there is demand for analyzing the consumption trends of consumers with the use of data of the existing POS system while suppressing capital investment.

However, in the conventional technology, it has been difficult to analyze the consumption trends of customers with the use of an existing POS system installed in the store, etc., while suppressing capital investment.

### SUMMARY OF THE INVENTION

The present invention provides an information processing system, an information processing method, and non-transitory computer-readable medium for executing the method, in which one or more of the above-described disadvantages are eliminated.

According to an aspect of the present invention, there is provided an information processing system including a sound wave transmitting device provided in a store, a terminal device and an information processing device. The sound wave transmitting device includes a first processor configured to: control the sound wave transmitting device to identify itself by outputting identification information as sound wave corresponding to a location of the sound wave transmitting device within the store. The terminal device includes a second processor configured to: receive the identification information that is output by the sound wave transmitting device, store the identification information along with a receiving time of the identification information, control to display a predetermined code information based on a determination whether the terminal device receives an operation for displaying the predetermined code information corresponding to product identification information that identifies a product in the store, and transmit, to the information processing device, identification information of a sound wave identification device and time information of receiving the identification information of the sound wave identification device along with the product identification information corresponding to a displayed predetermined code information in response to the predetermined code information being read by a predetermined reader device provided in the store. The information processing device includes a third processor configured to: store the identification information of the sound wave transmitting device, the time information and the product identification information received from the terminal device.

According to an aspect of the present invention, there is provided an information processing method implemented by a sound wave transmitting device provided in a store, a terminal device and an information processing device. The method includes: controlling, by the sound wave transmitting device, the sound wave transmitting device to identify itself by outputting identification information as sound wave corresponding to a location of the sound wave transmitting device within the store, receiving, by the terminal device, the identification information that is output by the sound wave transmitting device, storing, by the terminal device, the identification information along with a receiving time of the identification information, controlling to display, by the terminal device, a predetermined code information based on a determination whether the terminal device receives an operation for displaying the predetermined code information corresponding to product identification information that identifies a product in the store, and transmitting, by the terminal device, to the information processing device, identification information of a sound wave identification device and time information of receiving the identification information of the sound wave identification device along with the product identification information corresponding to a displayed predetermined code information in response to the predetermined code information being read by a predetermined reader device provided in the store, storing, by the information processing device, the identification information of the sound wave transmitting device, the time information and the product identification information received from the terminal device.

According to an aspect of the present invention, there is provided a non-transitory computer-readable medium having computer-readable instructions recorded thereon that are executable by a terminal device of an information processing system including a sound wave transmitting device and an information processing device. The sound wave transmitting device includes a first processor configured to: control the sound wave transmitting device to identify itself by outputting identification information as sound wave corresponding to a location of the sound wave transmitting device within the store. The computer-readable instructions causing the device to implement: receiving, by the terminal device, the identification information that is output by the sound wave transmitting device, storing, by the terminal device, the identification information along with a receiving time of the identification information, controlling to display, by the terminal device, a predetermined code information based on a determination whether the terminal device receives an operation for displaying the predetermined code information corresponding to product identification information that identifies a product in the store, and transmitting, by the terminal device, to the information processing device, identification information of a sound wave identification device and time information of receiving the identification information of the sound wave identification device along with the product identification information corresponding to a displayed predetermined code information in response to the predetermined code information being read by a predetermined reader device provided in the store. The information processing device includes a third processor configured to: store the identification information of the sound wave transmitting device, the time information and the product identification information received from the terminal device.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a configuration of an information processing system according to an embodiment;

FIG. 2 illustrates an example of a configuration of a position information management system according to a first embodiment;

FIG. 3 illustrates an example of a configuration of a plurality of areas according to the first embodiment;

FIGS. 4A through 4C illustrate a POS system according to the first embodiment;

FIG. 5 illustrates an example of a hardware configuration of a computer according to the first embodiment;

FIG. 6 illustrates an example of a hardware configuration of a transmitting device according to the first embodiment;

FIG. 7 illustrates an example of a hardware configuration of a detection device according to the first embodiment;

FIG. 8 illustrates an example of a hardware configuration of a gateway according to the first embodiment;

FIG. 9 illustrates an example of a hardware configuration of a POS register according to the first embodiment;

FIG. 10 illustrates a functional configuration of an information processing system according to the first embodiment;

FIGS. 11A and 11B illustrate examples of detection history information according to the first embodiment;

FIG. 12A illustrates an example of purchase history information according to the first embodiment;

FIG. 12B illustrates an example of consolidation information according to the first embodiment;

FIG. 13 is a sequence diagram of an example of a process by the information processing system according to the first embodiment;

FIG. 14 illustrates an example of a screen of an analysis menu according to the first embodiment;

FIG. 15 illustrates an example of a display screen of analysis results according to the first embodiment;

FIG. 16 illustrates another example of a display screen of analysis results according to the first embodiment;

FIG. 17 a functional configuration of the information processing system according to a second embodiment;

FIG. 18 illustrates an example of display information according to the second embodiment;

FIG. 19 illustrates an example of consolidation information according to the second embodiment;

FIG. 20 illustrates an example of a screen of an analysis menu according to the second embodiment;

FIG. 21 illustrates an example of a display screen of an analysis result according to the second embodiment;

FIG. 22 illustrates an example of a configuration of the position information management system according to a third embodiment;

FIG. 23 illustrates an example of a hardware configuration of a transmitting device according to the third embodiment;

FIG. 24 illustrates an example of a hardware configuration of an information terminal according to the third embodiment;

FIG. 25 illustrates a functional configuration of the position information management system according to the third embodiment;

FIG. 26 illustrates an example of association information according to the third embodiment;

FIG. 27 is a flowchart of an example of a process by the information terminal according to the third embodiment;

FIG. 28 is a flowchart of another example of a process by the information terminal according to the third embodiment; and

FIGS. 29A and 29B illustrate examples of display screens of the information terminal according to the third embodiment.

### DETAILED DESCRIPTION OF THE PREFERRED EMBODIMENTS

In the existing technology, the POS system (predetermined aggregation system) identifies an individual by a point card, etc., and reports the purchase product information to a personal feature analysis device, a customer database device, etc., and therefore it is difficult to divert the information of the existing POS system. Furthermore, in the system of the existing technology, there is a need to install many pieces of equipment in addition to a flow line analysis device, such as a plurality of cameras, a photograph control device, a personal feature analysis device, a customer database device, etc.

Embodiments of the present invention will be described below with reference to the accompanying drawings.

### <System Configuration>

First, a description is given of a configuration of an information processing system according to the present embodiment.

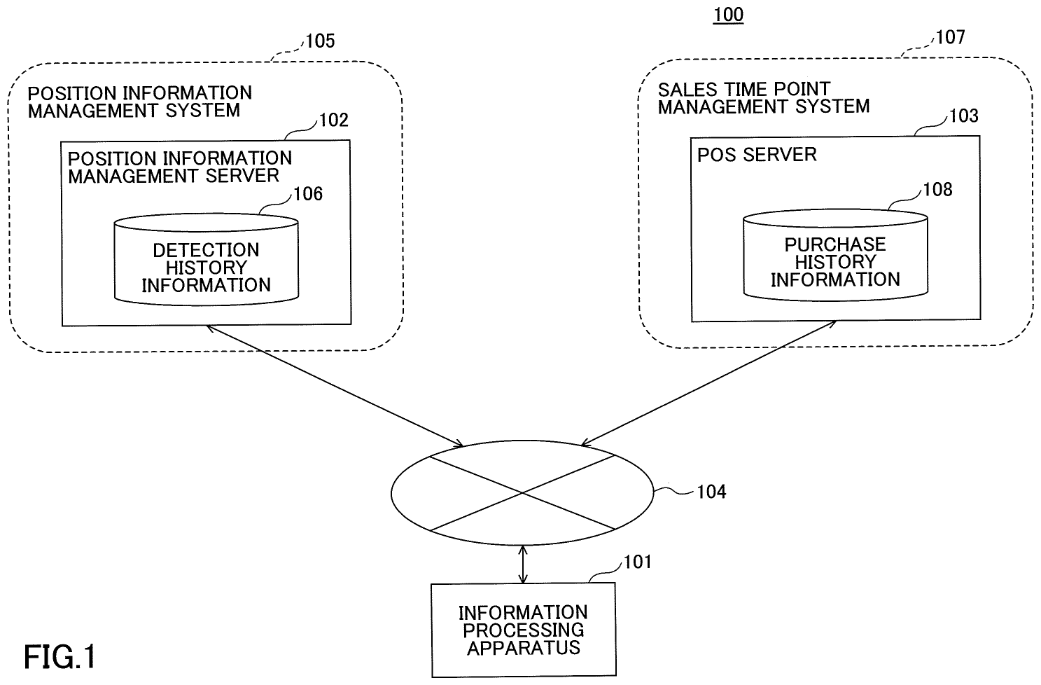

FIG. 1 illustrates an example of a configuration of an information processing system according to an embodiment. An information processing system 100 includes an information processing apparatus 101, a position information management server 102, and a POS (Point Of Sales) server 103, which are able to communicate with each other via a network 104 (communication channel) such as the Internet, LAN (Local Area Network), etc.

The information processing apparatus 101 is an information terminal such as a PC (Personal Computer), a tablet terminal, a smartphone, etc. In the information processing apparatus 101, an application program (hereinafter, “application”) corresponding to the information processing system 100 is installed.

The position information management server (position information management device) 102 is included in a position information management system 105 that manages information relevant to the position of a predetermined object by using, for example, RFID (Radio Frequency Identifier), sound waves, etc. Note that a predetermined object includes objects that can be carried such as a cart, a basket, an information terminal, a carriage, etc., and a wearable object such as ornaments including a watch, glasses, etc., clothes, etc. The position information management server 102 stores and manages information such as the position, the area, etc., where a predetermined object including first identification information is detected, and information of the time and date when the predetermined object is detected, etc., in association with each other, as detection history information 106.

The POS server (POS device) 103 is included in a sales time point management system (hereinafter, also referred to as “POS system”, which is an example of a predetermined aggregation system) 107 for managing the sales history, etc., of a product in a store, etc., based on second identification information for identifying a plurality of articles (products, etc.). The POS server 103 stores and manages information of sold products based on the second identification information read by a predetermined reading device (a barcode reader, etc.) at the cash register, etc., as purchase history information 108.

In the above configuration, it is assumed that the position information management server 102 manages the detection history information 106 of a cart based on, for example, a product identification code (first identification information) that can be used by the POS system 107, which is displayed on the cart (an example of the predetermined object), etc.

Furthermore, it is assumed that the POS server 103 manages the purchase history information 108, which includes a product identification code of a cart, and a product identification code (second identification information) of one or more products purchased by using the cart, which are read by a predetermined reading device.

Furthermore, by executing an application corresponding to the information processing system 100, the information processing apparatus 101 acquires the detection history information 106 from the position information management server 102 and acquires the purchase history information 108 from the POS server 103. Furthermore, the information processing apparatus 101 manages the acquired detection history information 106 and purchase history information 108 in association with each other, based on the product identification code (first identification information) of the cart.

Accordingly, for example, the information processing apparatus 101 can identify the detection history information 106 of a cart when one or more of the above products is purchased, and analyze information such as the flow line of the cart, the staying time within a predetermined area, consumption trends, etc. The information processing system 100 according to the present embodiment facilitates the operation of analyzing the consumption trends of customers with the use of the existing POS system installed in the store, etc., while suppressing capital investment.

Next, a plurality of embodiments are described with reference to specific examples.

### First Embodiment

### <System Configuration>

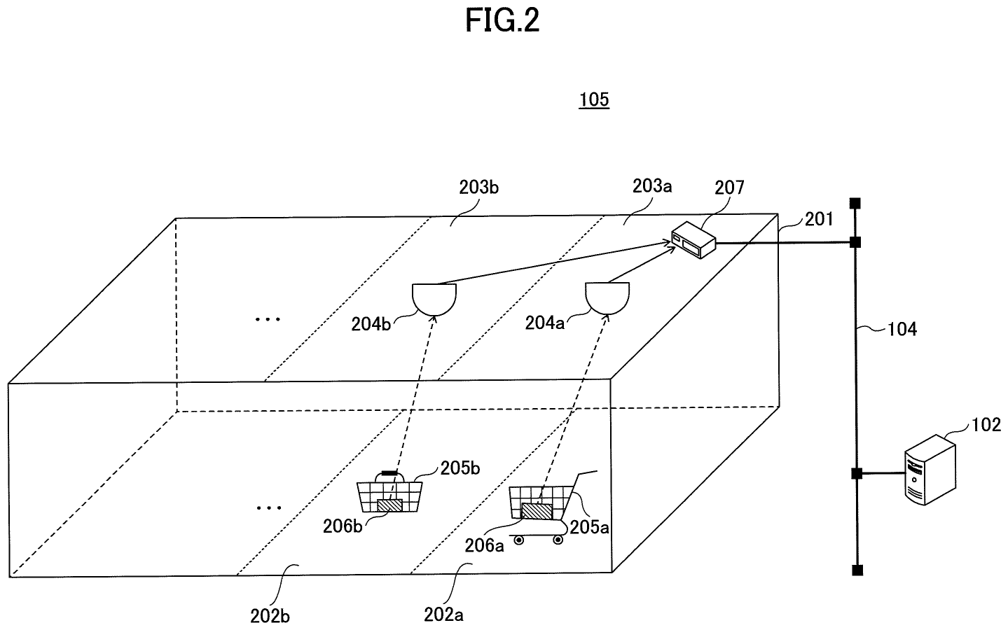

FIG. 2 illustrates an example of a configuration of the position information management system 105 according to a first embodiment. The position information management system 105 includes the position information management server 102, a gateway 207, a plurality of detection devices 204a, 204b, and a plurality of carts 205a, 205b.

The plurality of detection devices 204a, 204b are respectively provided on, for example, ceilings 203a, 203b, etc., which respectively correspond to a plurality of areas 202a, 202b specified in advance by dividing the floor of a store 201, etc. Note that in the following description, any one of the plurality of detection devices 204a, 204b is indicated as a “detection device 204”. Furthermore, the number of detection devices 204 in FIG. 2 is one example; the number of detection devices 204 may be any number of two or more.

The detection device 204 can communicate with the gateway 207 by predetermined wireless communication. Furthermore, the detection device 204 acquires the identification information transmitted by a predetermined transmitting device in an area corresponding to the own device, and sends the acquired identification information and the identification information of the own device stored in advance (or identification information of an area, etc.), to the position information management server 102 via the gateway 207.

The gateway 207 can communicate with a plurality of detection devices 204 by predetermined wireless communication, and can communicate with the position information management server 102 via the network 104, etc. Furthermore, the gateway 207 relays the transmission and reception of data between a plurality of detection devices 204 and the position information management server 102. Accordingly, the plurality of detection devices 204 and the position information management server 102 are able to transmit and receive data via the gateway 207.

To the plurality of carts 205a, 205b, transmitting devices 206a, 206b including first identification information are respectively attached. Note that in the following description, any one of the plurality of plurality of carts 205a, 205b is indicated as a “cart 205”. Similarly, any one of the plurality of transmitting devices 206a, 206b is indicated as a “transmitting device 206”. Note that the number of carts 205 in FIG. 2 is one example, the number of carts 205 may be any other number.

The cart 205 is an article such as a basket, a bag, a carrier, a cart, etc., used by the user of a store when purchasing products. The cart 205 is an example of a predetermined object including first identification information. Note that the cart 205 may have various modes; however, in this example, it is assumed that various predetermined objects used when the user purchases products are referred to as a cart 205. In the example of FIG. 2, the transmitting device 206 is provided on the inside or the outside the bottom of the cart 205.

As the transmitting device 206, for example, an active tag of RFID (Radio Frequency IDentification), etc., may be applied. The active tag has a built-in battery, and sends signals including identification information recorded in the active tag, at predetermined time intervals. For example, the active tag can operate for over five years by one button battery, by setting the predetermined time interval of sending signals at approximately 30 seconds. Note that the active tag of RFID is an example of the transmitting device 206. For example, the transmitting device 206 may be a semi-active tag, etc., for sending signals in response to predetermined acceleration, signals, etc., or a wireless terminal, etc., other than RFID.

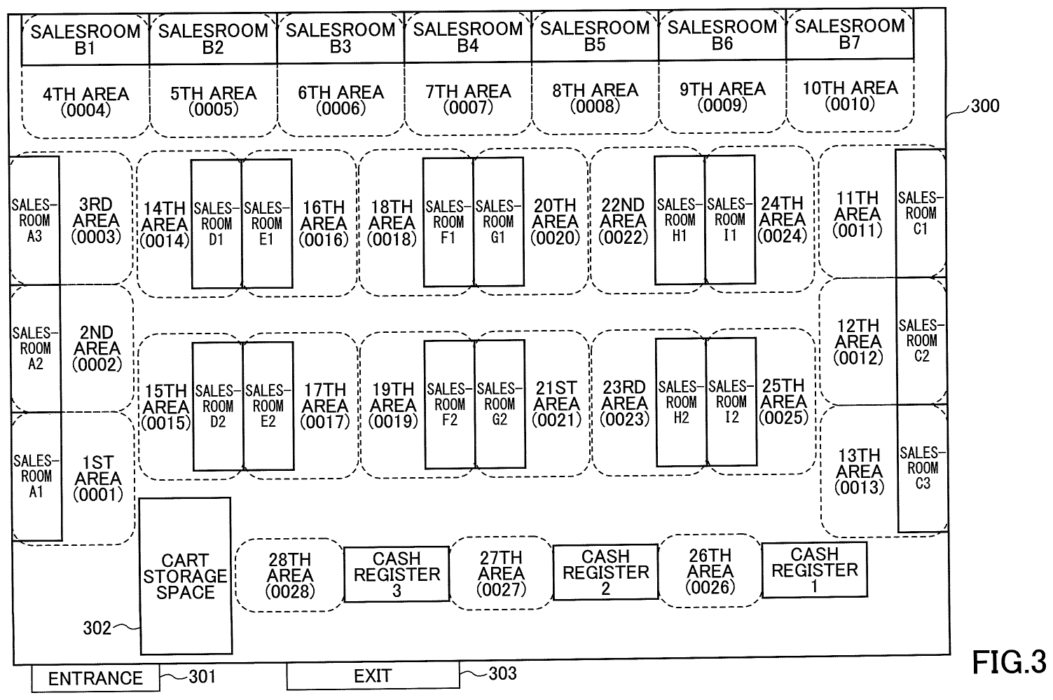

FIG. 3 illustrates an example of a configuration of a plurality of areas according to the first embodiment. FIG. 3 illustrates an example of the relationship between the arrangement of salesrooms on a floor of a store 300, and the plurality of areas. In the store 300, for example, the user enters the store 300 from an entrance 301, takes a cart 205 placed at a cart storage space 302, and selects a product in the store 300. Furthermore, it is assumed that the user goes to one of the cash registers 1 through 3 together with the cart 205 and one or more selected products, and then exits the store 300 from an exit 303 after checking out at the cash register.

In the example of FIG. 3, one area corresponding to each salesroom is specified, such as a “first area” with respect to “salesroom A1”, and a “second area” with respect to “salesroom A2”. However, this is merely one example; for example, two or more different salesrooms may be included in a single area, or a single salesroom may be divided across a plurality of areas.

Furthermore, in each of the areas (1st area through 28th area) of FIG. 3, a detection device 204 is installed, and the number in parenthesis in each area indicates the identification information of the detection device 204 installed in the area.

For example, the detection device 204 installed in the 1st area of FIG. 3 acquires identification information sent from the transmitting device 206 provided in the cart 205 in the 1st area, and sends the acquired identification information and the identification information “0001” of the detection device 204 to the position information management server 102.

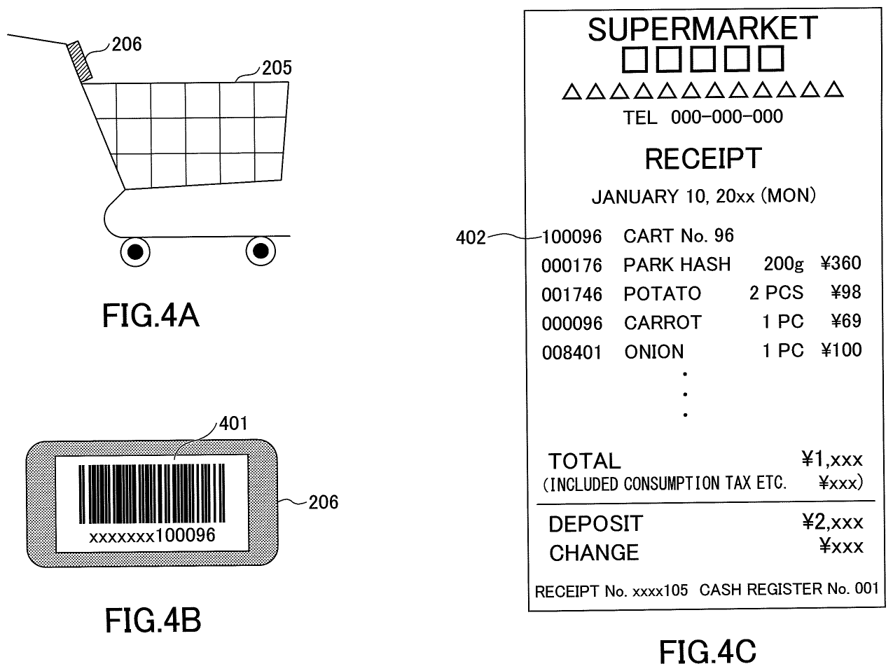

FIGS. 4A through 4C illustrate a POS system according to the first embodiment.

In the present embodiment, as illustrated in FIG. 4A, the cart 205 that is used in the store 300, etc., is provided with the transmitting device 206 such as an active tag (or a semi-active tag) of RFID. In the description with reference to FIG. 2, it is assumed that the transmitting device 206 is provided on an inner bottom surface or an outer surface of the cart 205; however, the position of attaching the transmitting device 206 may be any position as long as the reading device of a POS register can read the transmitting device 206.

FIG. 4B illustrates an example of the transmitting device 206. In the example of FIG. 4B, the transmitting device 206 is an active tag of RFID corresponding to a JAN (Japanese Article Number) code, and a JAN code 401 of the active tag is displayed so as to be read from outside. Accordingly, it is possible to read the JAN code 401 corresponding to the cart 205 by using a reading device of the POS register.

Note that the JAN code 401 is an example of first identification information relevant to the cart 205. The JAN code is a product identification code that is widely used in Japan. The JAN code corresponds to, for example, the EAN (European Article Number) used in Europe, etc., the UPC (Universal Product Code) used in the US, etc. The predetermined identification information according to the present embodiment may be a barcode of the JAN code, EAN, UPC, etc., or a two-dimensional code such as a QR code (registered trademark), etc.

A preferred example of the transmitting device 206 sends signals including first identification information (for example, the JAN code 401) corresponding to the own device, at predetermined time intervals (for examples, every 30 seconds). For example, by using SGTIN (Serialized Global Trade Item Number), etc., as the identification code recorded in the active tag of RFID, the transmitting device 206 can send signals including the JAN code 401 relevant to the own device. SGTIN is an example of an identification code for writing in to an RFID tag. SGTIN is an individual identification code for a product, which is formed by adding a serial number to the JAN code (GTIN).

Accordingly, the position information management server 102 is able to identify the area where the cart 205 is positioned, based on the first identification information included in the signal detected by the detection device 204 installed in each area.

Furthermore, in another example, the transmitting device 206 may send signals including identification information (third identification information) of the own device different from the first identification information. In this case, the position information management server 102 stores, in advance, the first identification information (JAN code 401, etc.) of the cart 205, and the identification information (third identification information) of the transmitting device 206, in association with each other. Accordingly, the position information management server 102 is able to identify the area where the cart 205 is positioned, based on the identification information of the transmitting device 206.

Note that the following description is given assuming that the transmitting device 206 sends signals including the product identification code (example of first identification information) such as the JAN code 401, etc., corresponding to the cart 205, at predetermined time intervals.

FIG. 4C illustrates an image of a receipt issued at the POS register. The store clerk of the store 300, etc., uses a predetermined reading device (barcode reader, etc.) of the POS register, for example, to read the product identification code (first identification information) of the transmitting device 206 provided in the cart 205, and then reads the product identification codes (second identification information) of the products. Accordingly, the POS server 103 is able to manage the cart 205 in the same manner as the other products. In the example of FIG. 4C, information 402 of the cart 205 is the product name “CART NO. 96”, which is displayed as a product without price information. Note that the above-described timing of reading the product identification code of the transmitting device 206 is one example; the product identification code may be read at another timing, such as after the product identification codes of the products have been read.

Note that the following description is given assuming that the product identification code relevant to the cart 205 (first identification information) and the product identification code for identifying a product of the store, etc., (second identification information) are identification information having the same format (JAN code, etc.). However, this is merely one example; the first identification information relevant to the cart 205 may be identification information having a different format from that of the second identification information relevant to a product of the store, etc., as long as the identification information can be handled by the sales time point management system 107.

As described above, in the present embodiment, the position information management server 102 manages the detection history information 106 of the cart 205 based on the product identification code, etc., of the cart 205. Furthermore, the POS server 103 reads the product identification code of the cart 205 and one or more products, by the reading device of the POS register, and manages the purchase history information 108 based on the product identification codes, etc., that have been read.

### <Hardware Configuration>

Next, a description is given of the hardware configuration of the devices.

(Hardware Configuration of Image Processing Apparatus, Position Information Management Server, and POS Server)

The information processing apparatus 101, the position information management server 102, and the POS server 103 have a configuration of a general computer.

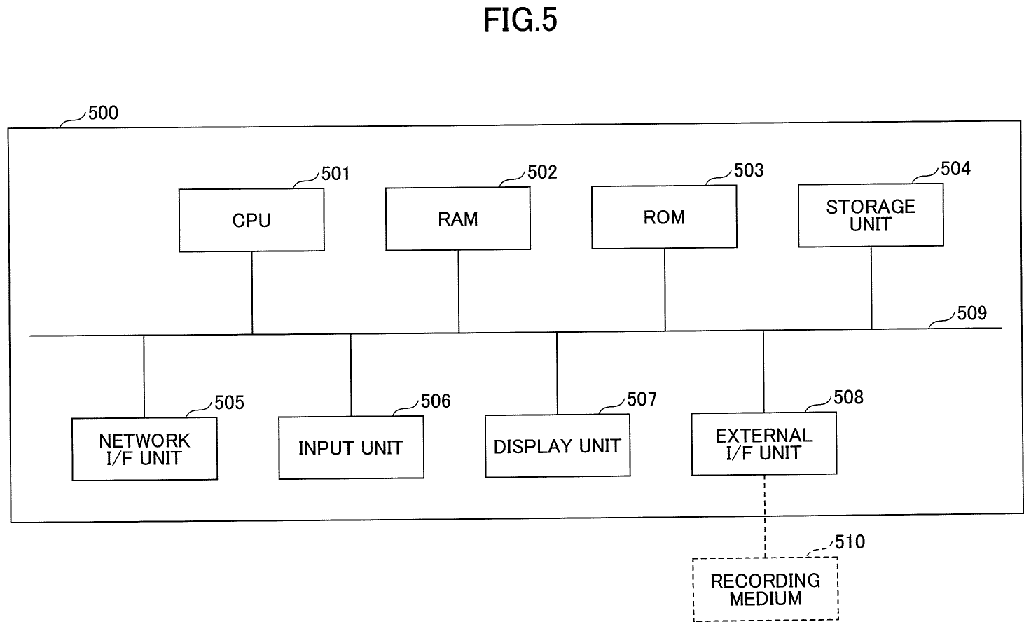

FIG. 5 illustrates an example of a hardware configuration of a computer according to the first embodiment. A computer 500 includes, for example, a CPU (Central Processing Unit) 501, a RAM (Random Access Memory) 502, a ROM (Read Only Memory) 503, a storage unit 504, a network I/F (Interface) unit 505, an input unit 506, a display unit 507, an external I/F unit 508, a bus 509, etc.

The CPU 501 is an arithmetic device for implementing various functions of the computer 500, by loading the programs and data stored in the ROM 503, the storage unit 504, etc., into the RAM 502, and executing processes. The RAM 502 is a volatile memory used as a work area, etc., of the CPU 501. The ROM 503 is a non-volatile memory for holding programs and data even after the power is turned off.

The storage unit 504 is a high capacity storage device such as a HDD (Hard Disk Drive), SSD (Solid State Drive), etc., and stores an OS (Operating System), an application program, various kinds of data, etc.

The network I/F unit 505 is a communication interface for connecting the computer 500 to the network 104.

The input unit 506 is an input device such as a pointing device such as a mouse, and a keyboard, etc., and is used for inputting operation signals in the computer 500.

The display unit 507 is a display device such as display, etc., and displays processing results, etc., by the computer 500.

The external I/F unit 508 is an interface between the computer 500 and an external device. An example of the external device is a recording medium 510, etc. The computer 500 is able to read and/or write data in the recording medium 510 via the external I/F unit 508. Examples of the recording medium 510 are an optical disk, a magnetic disk, a memory card, a USB (Universal Serial Bus) memory, etc. Furthermore, the computer 500 stores a predetermined program in the recording medium 510, and installs the program stored in the recording medium 510 in the computer 500 via the external I/F unit 508, such that the predetermined program becomes executable.

The bus 509 is connected to the respective elements described above, and transmits address signals, data signals, various control signals, etc.

Note that the configuration of FIG. 5 is merely an example. For example, the computer 500 may have the input unit 506 and the display unit 507 provided externally, and the input unit 506 and the display unit 507 may integrally constitute a display input device such as a touch panel display.

(Hardware Configuration of Transmitting Device)

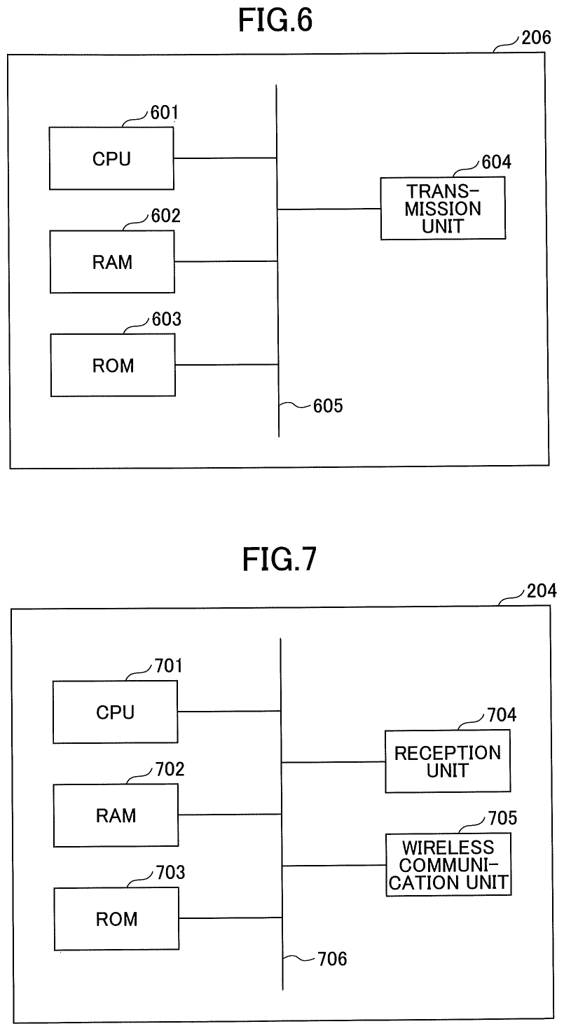

FIG. 6 illustrates an example of a hardware configuration of the transmitting device 206 according to the first embodiment.

The transmitting device 206 includes, for example, a CPU 601, a RAM 602, a ROM 603, a transmission unit 604, a bus 605, etc.

The CPU 601 is an arithmetic device for implementing various functions of the transmitting device 206, by executing programs stored in the ROM 603, etc. The RAM 602 is a volatile memory used as a work area, etc., of the CPU 601. The ROM 603 is a non-volatile memory for storing programs, etc., of the transmitting device 206. The ROM 603 may be a rewritable, non-volatile memory such as a flash ROM, an EEPROM (Electrically Erasable Programmable Read-Only Memory), etc.

The transmission unit 604 includes, for example, a transmission circuit for sending predetermined wireless signals of RFID, etc., an antenna, etc. An example of the predetermined wireless signals is weak radio of a 315 MHz band. In this case, the communicable distance (reach distance) of the predetermined wireless signals transmitted by the transmitting device 206 is, for example, approximately 10 m.

The bus 605 is connected to the respective elements described above, and transmits address signals, data signals, various control signals, etc.

(Hardware Configuration of Detection Device)

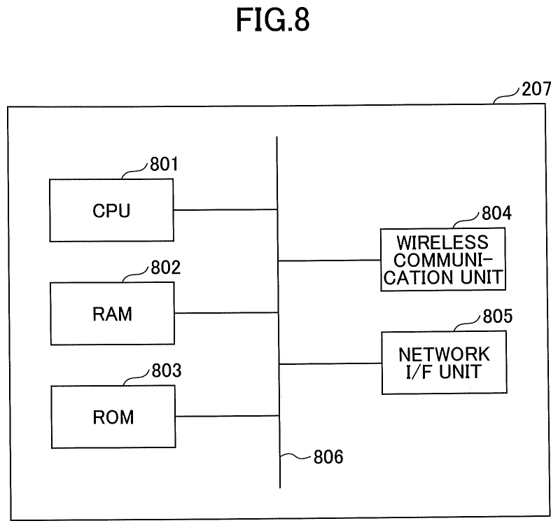

FIG. 7 illustrates an example of a hardware configuration of the detection device 204 according to the first embodiment. The detection device 204 includes, for example, a CPU 701, a RAM 702, a ROM 703, a reception unit 704, a wireless communication unit 705, a bus 706, etc.

The CPU 701 is an arithmetic device for implementing various functions of the detection device 204, by executing programs stored in the ROM 703, etc. The RAM 702 is a volatile memory used as a work area, etc., of the CPU 701. The ROM 703 is a non-volatile memory for storing programs, etc., of the detection device 204. The ROM 703 may be a rewritable, non-volatile memory such as a flash ROM, an EEPROM, etc.

The reception unit 704 includes, for example, a reception circuit for receiving predetermined wireless signals of RFID, etc., an antenna, etc.

The wireless communication unit 705 includes, for example, a transmission reception circuit, an antenna, etc., for performing wireless communication with the gateway 207, by a wireless communication method that is different from that of the reception unit 704. In the present embodiment, it is assumed that the wireless communication unit 705 performs communication with the gateway 207, by using, for example, wireless LAN, Zigbee (registered trademark), or a specific power saving radio circuit (IEEE 802.15.4g) of a 920 MHz band, etc.

The bus 706 is connected to the respective elements described above, and transmits address signals, data signals, various control signals, etc.

(Hardware Configuration of Gateway)

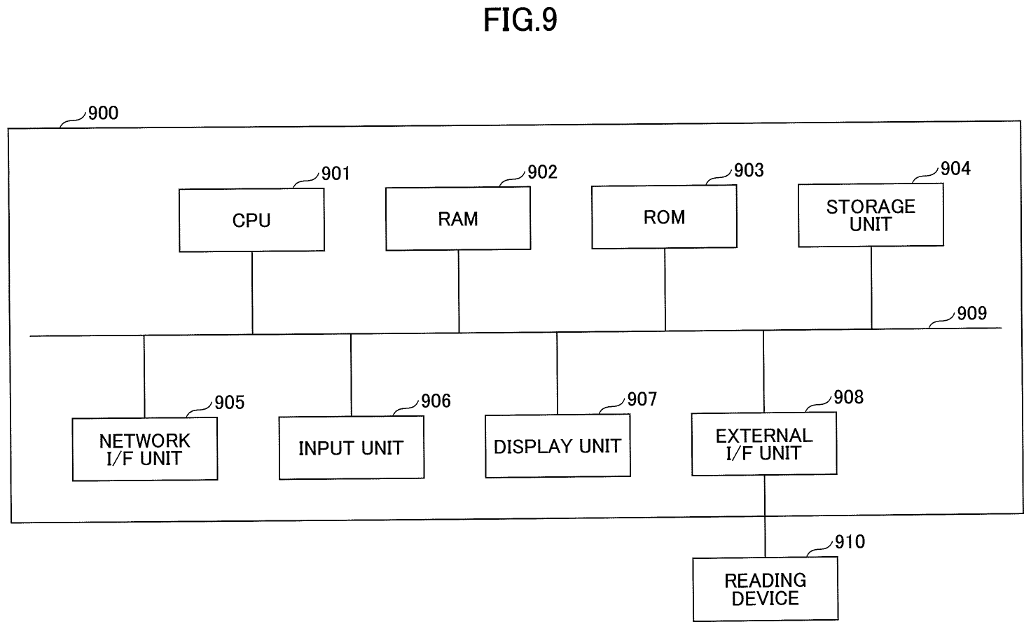

FIG. 8 illustrates an example of a hardware configuration of the gateway 207 according to the first embodiment. The gateway 207 includes, for example, a CPU 801, a RAM 802, a ROM 803, a wireless communication unit 804, a network I/F unit 805, a bus 806, etc.

The CPU 801 is an arithmetic device for implementing various functions of the gateway 207, by executing programs stored in the ROM 803, etc. The RAM 802 is a volatile memory used as a work area, etc., of the CPU 801. The ROM 803 is a non-volatile memory for storing programs, etc., of the gateway 207. The ROM 803 may be a rewritable, non-volatile memory such as a flash ROM, an EEPROM, etc.

The wireless communication unit 804 includes, for example, a wireless circuit, an antenna, etc., for performing wireless communication, by the same wireless communication method as that of the wireless communication unit 705 of the detection device 204 described above.

The network I/F unit 805 is a communication interface for connecting the gateway 207 to the network 104.

The bus 806 is connected to the respective elements described above, and transmits address signals, data signals, various control signals, etc.

(Hardware Configuration of POS Register)

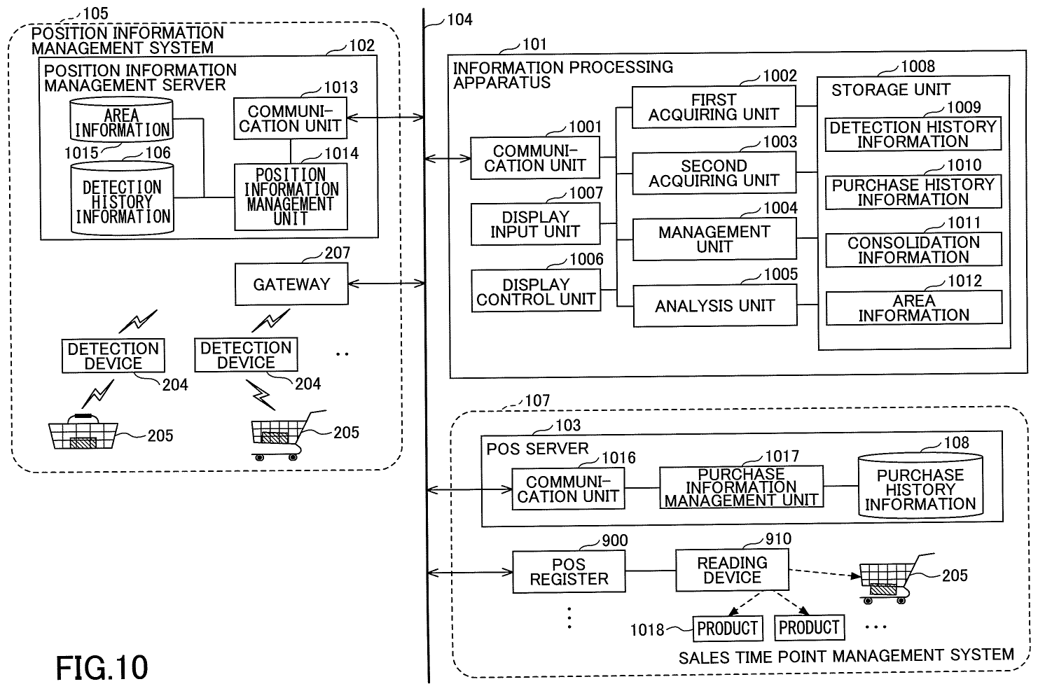

FIG. 9 illustrates an example of a hardware configuration of a POS register according to the first embodiment. A POS register 900 includes, for example, a CPU 901, a RAM 902, a ROM 903, a storage unit 904, a network I/F unit 905, an input unit 906, a display unit 907, an external I/F unit 908, a bus 909, etc.

The CPU 901 is an arithmetic device for implementing various functions of the POS register 900, by loading the programs and data stored in the ROM 903, the storage unit 904, etc., into the RAM 902, and executing processes. The RAM 902 is a volatile memory used as a work area, etc., of the CPU 901. The ROM 903 is a non-volatile memory for holding programs and data even after the power is turned off.

The storage unit 904 is a high capacity storage device such as a HDD, SSD, etc., and stores an OS, an application program, various kinds of data, etc.

The network I/F unit 905 is a communication interface for connecting the POS register 900 to the network 104.

The input unit 906 is an input device such as a keyboard, etc., and is used for inputting operation signals in the POS register 900.

The display unit 907 is a display device such as display, etc., and displays processing results, etc., by the POS register 900.

The external I/F unit 908 is an interface between the POS register 900 and an external device. An example of the external device is a reading device 910, etc.

The reading device 910 is a barcode reader, a two-dimensional code reader, etc., for reading a product identification code (predetermined identification information) such as a JAN code, etc., displayed on the cart 205, a product, etc.

The bus 909 is connected to the respective elements described above, and transmits address signals, data signals, various control signals, etc.

### <Functional Configuration>

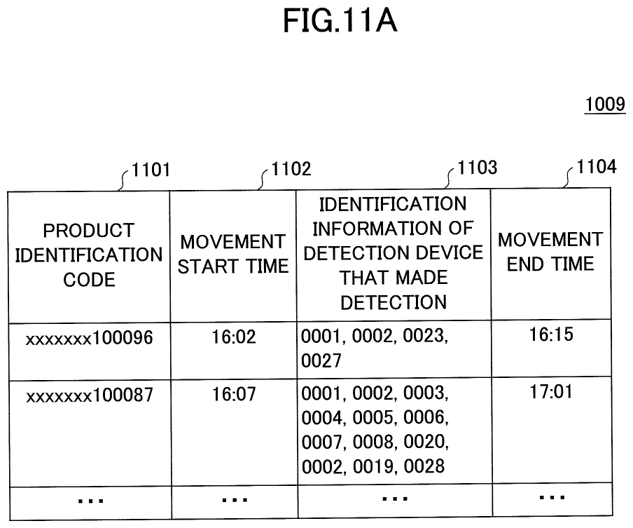

FIG. 10 illustrates a functional configuration of the information processing system 100 according to the first embodiment.

(Functional Configuration of Information Processing Apparatus)

The information processing apparatus 101 includes a communication unit 1001, a first acquiring unit 1002, a second acquiring unit 1003, a management unit 1004, an analysis unit 1005, a display control unit 1006, a display input unit 1007, and a storage unit 1008.

The communication unit 1001 is a unit for connecting the information processing apparatus 101 to the network 104, and transmitting and receiving data with the position information management server 102, the POS server 103, etc. The communication unit 1001 is realized by, for example, the network I/F unit 505 of FIG. 5, programs operating in the CPU 501 of FIG. 5, etc.

The first acquiring unit 1002 acquires detection history information of a predetermined object having first identification information, from the position information management server 102 managing the detection history information of the predetermined object. For example, the first acquiring unit 1002 acquires, from the position information management server 102, the detection history information of the cart 205 (example of predetermined object) having a product identification code (example of first identification information) such as a JAN code, etc.

Preferably, the first acquiring unit 1002 stores the acquired detection history information as, for example, detection history information 1009 in the storage unit 1008, etc.

Furthermore, in another example, the first acquiring unit 1002 may acquire the detection information sent from the detection device 204, via the gateway 207, without using the position information management server 102, and store the acquired information as the detection history information 1009 in the storage unit 1008.

The second acquiring unit 1003 acquires, from the POS server 103, purchase history information including first identification information relevant to a predetermined object and second identification information relevant to one or more articles (products) corresponding to the predetermined object, read by the reading device 910 of the POS register 900. For example, the second acquiring unit 1003 acquires, from the POS server 103, purchase history information including a product identification code of the cart 205 and product identification codes of one or more products 1018 corresponding to the cart 205, read by the reading device 910 of the POS register 900.

Preferably, the second acquiring unit 1003 stores the acquired purchase history information, as purchase history information 1010 in, for example, the storage unit 1008, etc.

Furthermore, in another example, the second acquiring unit 1003 may acquire purchase history information from the POS register 900 via the network 104 without using the POS server 103, and store the purchase history information as the purchase history information 1010 in the storage unit 1008.

The management unit 1004 manages the detection history information 1009 acquired by the first acquiring unit 1002 and the purchase history information 1010 acquired by the second acquiring unit 1003 in association with each other, based on the first identification information relevant to a predetermined object. For example, the management unit 1004 manages the detection history information 1009 and the purchase history information 1010 stored in the storage unit 1008 in association with each other, based on a product identification code (JAN code, etc.) of the cart 205.

Preferably, the management unit 1004 stores the information in which the detection history information 1009 and the purchase history information 1010 are associated with each other, as consolidation information 1011 in the storage unit 1008.

The analysis unit 1005 analyzes predetermined information, based on the purchase history information and the detection history information associated with the purchase history information. For example, the analysis unit 1005 analyzes the flow line, the staying time, etc., when one or more products 1018 corresponding to the cart 205 have been purchased, based on the consolidation information 1011, in which the detection history information 1009 and the purchase history information 1010 are stored in association with each other.

The display control unit 1006 causes the display input unit 1007, etc., to display the information analyzed by the analysis unit 1005.

Note that the above first acquiring unit 1002, the second acquiring unit 1003, the management unit 1004, the analysis unit 1005, and the display control unit 1006 are realized by, for example, programs operating in the CPU 501 of FIG. 5, etc.

The display input unit 1007 displays, for example, an analysis menu described below and information obtained as an analysis result, etc., by the analysis unit 1005, according to control by the display control unit 1006. Furthermore, for example, the display input unit 1007 receives an input operation by the user, with respect to an analysis menu, etc. The display input unit 1007 is realized by, for example, the input unit 506 and the display unit 507 of FIG. 5 and programs operating in the CPU 501 of FIG. 5, etc.

The storage unit 1008 stores, for example, the detection history information 1009, the purchase history information 1010, the consolidation information 1011, area information 1012, etc.

The area information 1012 is information indicating a floor layout of the store 300 as illustrated in FIG. 3, the arrangement of salesrooms, and the relationship between the arrangements of salesrooms a plurality of areas. The information processing apparatus 101 may store the area information 1012 in advance, or may acquire the area information 1012 from the position information management server 102 by, for example, the first acquiring unit 1002. Alternatively, the area information 1012 may be provided by an application for the information processing system 100 installed in the information processing apparatus 101.

(Functional Configuration of Position Information Management Server)

The position information management server 102 includes a communication unit 1013, a position information management unit 1014, area information 1015, and the detection history information 106.

The communication unit 1013 is a unit for connecting the position information management server 102 to the network 104, and for transmitting and receiving data with the gateway 207, the information processing apparatus 101, etc. The communication unit 1013 is realized by, for example, the network I/F unit 505 of FIG. 5, programs operating in the CPU 501 of FIG. 5, etc.

The position information management unit 1014 receives detection information reported from a plurality of detection devices 204, via the gateway 207, and manages the detection information as the detection history information 106. The detection information reported from a plurality of detection devices 204 includes, for example, the identification information of the detection device 204 and a product identification code (JAN code, etc.) relevant to the cart 205 or the identification information (tag ID, etc.) of the transmitting device 206 provided in the cart 205 detected by the detection device 204.

The position information management unit 1014 identifies the area where predetermined identification information of the cart 205 is detected, based on the detection information reported from the detection device 204 and the area information 1015. An area where the predetermined identification information is detected is expressed by, for example, a salesroom name (for example, a salesroom A1 in FIG. 3, etc.), an area name (for example, a 1st area in FIG. 3, etc.), or identification information of the detection device 204, etc.

Furthermore, the position information management unit 1014 identifies the product identification code (JAN code, etc.) of the cart 205, based on the detection information reported from the detection device 204. For example, when the identification information of the transmitting device 206 is included in the detection information, the position information management unit 1014 is able to identify the product identification code of the cart 205, by storing, in advance, information in which the predetermined identification information of the cart 205 and the identification information of the transmitting device 206 are associated with each other.

Furthermore, for example, the position information management unit 1014 stores, in the detection history information 106, the product identification code relevant to the cart 205, the information of the area where the cart 205 is detected, and the information (date, time, etc.) relevant to the time when the cart 205 is detected, in association with each other.

Furthermore, the position information management unit 1014 provides part of or all of the detection history information 106 to the information processing apparatus 101, in response to a request from the information processing apparatus 101.

The area information 1015 is information indicating a floor layout of the store 300 as illustrated in FIG. 3, the arrangement of salesrooms, and the relationship between the arrangements of salesrooms a plurality of areas.

The position information management unit 1014 provides part of or all of the area information 1015 to the information processing apparatus 101, in response to a request from the information processing apparatus 101.

Note that the detection history information 106 and the area information 1015 may be realized by a storage unit of the same server device as that of the position information management unit 1014, or may be realized by another server device.

(Functional Configuration of POS Server)

The POS server 103 includes a communication unit 1016, a purchase information management unit 1017, purchase history information 1018, etc.

The communication unit 1016 is a unit for connecting the POS server 103 to the network 104, and for transmitting and receiving data with the information processing apparatus 101, etc. The communication unit 1016 is realized by, for example, the network I/F unit 505 of FIG. 5, programs operating in the CPU 501 of FIG. 5, etc.

The purchase information management unit 1017 is for acquiring and managing purchase history information 108 including a product identification code (first identification information) relevant to the cart 205 and a product identification code (second identification information) of one or more products 1018 corresponding to the cart, read by the reading device 910. Furthermore, the purchase information management unit 1017 provides part of or all of the purchase history information 108 to the information processing apparatus 101, in response to a request from the information processing apparatus 101.

### <Examples of Information >

Next, a description is given of examples of information handled by the information processing apparatus 101. Note that in the following description, it is assumed that the first identification information corresponding to the cart 205 and the second identification information for identifying one or more products, are product identification codes having the same format (JAN code, etc.). However, this is merely one example, and the scope of the present invention is not so limited.

(Detection History Information)

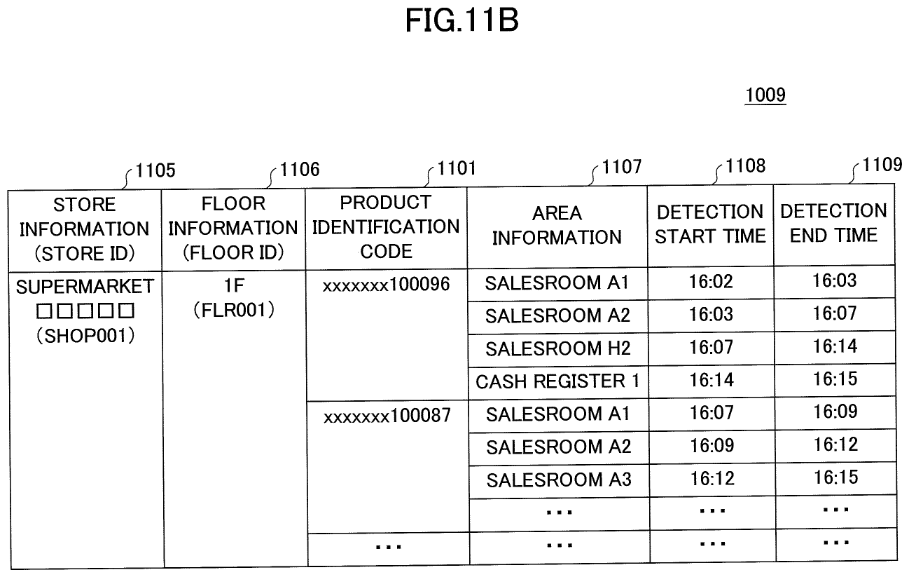

FIGS. 11A and 11B illustrate examples of detection history information according to the first embodiment.

FIG. 11A illustrates one example of the detection history information. The detection history information 1009 illustrated in FIG. 11A includes information such as a product identification code 1101 (example of first identification information), a movement start time 1102, identification information of detection device that made detection 1103, movement end time 1104, etc.

The product identification code 1101 is identification information such as a JAN code, etc., corresponding to the detected cart 205.

The movement start time 1102 is information (date, time, etc.) relevant to the time when detection of the product identification code 1101 has started.

The identification information of detection device that made detection 1103 is information in which the identification information of the detection devices 204 that have detected the product identification code 1101 is sequentially recorded.

For example, with reference to FIG. 3, when a user enters the 1st area with the cart 205 from a cart storage space 302, the detection device 204 corresponding to the 1st area receives the product identification code (first identification information) relevant to the cart 205, from the transmitting device 206 of the cart 205. Furthermore, the detection device 204 corresponding to the 1st area sends the product identification code received from the transmitting device 206 of the cart 205 and the detection information including the identification information “0001” of the own device, to the position information management server 102.

Similarly, when a user enters the 2nd area from the 1st area of FIG. 3, the detection device 204 corresponding to the 2nd area sends the product identification code received from the transmitting device 206 of the cart 205 and the detection information including the identification information “0002” of the own device, to the position information management server 102.

The position information management server 102 sequentially stores the identification information 1103 of the detection devices 204 that have detected the product identification code 1101 of the same cart 205, based on the detection information sent from a plurality of detection devices 204. For example, the example of FIG. 11A indicates that the product identification code 1101 “xxxxxxx100096” has been detected in the order of “1st area”, “2nd area”, “23rd area”, and “27th area”, with reference to the product identification code 1101 of the detection device that made the detection, and FIG. 3.

The movement end time 1104 is the information of the time (or date) when detection of the product identification code has ended. The movement end time 1104 may be, for example, the time (or date) when the product identification code 1101 is detected in the area where the bill is paid for the products, that is, where the user checked out at the cash register (for example, the 26th area through the 28th area in FIG. 3).

FIG. 11B illustrates another example of the detection history information. The detection history information 1009 illustrated in FIG. 11B includes information such as store information (store id) 1105, floor information (floor id) 1106, a product identification code 1101, area information 1107, detection start time 1108, detection end time 1109, etc.

The store information 1105 and the floor information 1106 are identification information for identifying the store and the floor, respectively, and is used when the position information management server 102 manages a plurality of stores and a plurality of floors.

The product identification code 1101 is identification information (JAN code, etc.) for identifying a plurality of articles corresponding to the detected cart 205.

The area information 1107 is information for identifying the area where the product identification code 1101 of the cart 205 has been detected. For example, with reference to FIG. 3, the area information 1107 may be a salesroom name (for example, a salesroom A1, etc.), an area name (for example, a 1st area, etc.), or identification information of the detection device 204 installed in each area (for example, “0001”), etc. Here, a description is given assuming that the area information 1107 is a salesroom name.

The detection start time 1108 is information (time or date, etc.) relevant to the time when the product identification code 1101 is detected in each area.

The detection end time 1109 is information relevant to the time when the product identification code 1101 is no longer detected in any of the areas. Note that the position information management server 102 may use the time when the same product identification code 1101 is detected in a different area, as the detection end time 1109.

Note that the detection history information 1009 illustrated in FIG. 11B is merely an example. The detection history information 1009 may be in any other form as long as the information for identifying the area where the product identification code 1101 is detected and the information relevant to the detection time are stored in association with the product identification code 1101.

(Purchase History Information)

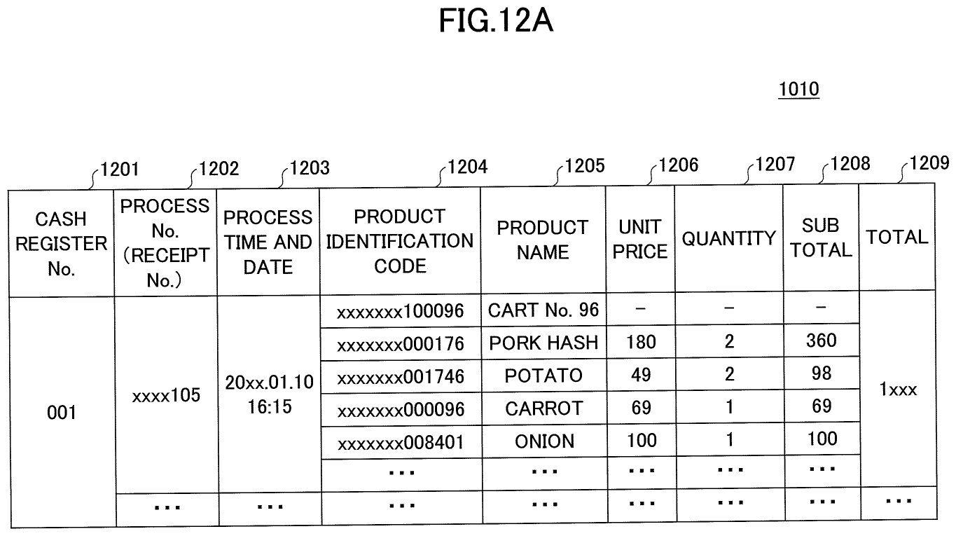

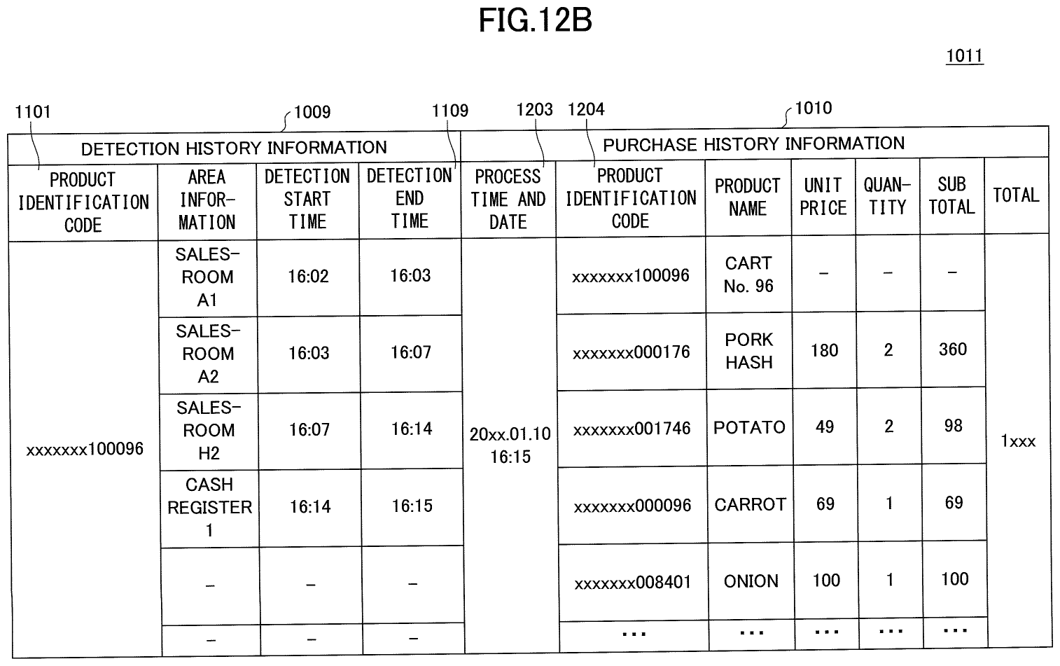

FIG. 12A illustrates an example of the purchase history information 1010. In the example of FIG. 12A, the purchase history information 1010 includes information of “cash register no.” 1201, “process no. (receipt no.)” 1202, process time and date 1203, product identification code 1204, product name 1205, unit price 1206, quantity 1207, subtotal 1208, total 1209, etc.

The “cash register no.” 1201 is information (number or identification information) for identifying the POS register 900 where user has checked out.

The “process no.” 1202 is information (number or identification information) issued in units of checkouts (or receipts).

The process time and date 1203 is information indicating the time and date when a predetermined process such as checking out, etc., has been performed.

The product identification code 1204 is identification information such as a JAN code relevant to the cart 205 and one or more products 1018 purchased by using the cart 205, which are read by the reading device 910 of the POS register 900 at the time of checkout.

The product name 1205 is information of a product name corresponding to each product identification code 1204.

The unit price 1206 is information of a unit price corresponding to each product identification code 1204. The example of FIG. 12A indicates that a unit price 1206 corresponding to the product identification code 1204 of the cart 205, is not registered.

The quantity 1207 is information of the purchased quantity corresponding to each product identification code 1204.

The sub total 1208 is information of the amount of money that is the sub total corresponding to each product identification code 1204.

The total 1209 is information of the total amount corresponding to the “process no.” 1202.

As described above, the purchase history information 1010 according to the present embodiment includes the product identification codes relevant to the cart 205.

(Consolidation Information)

FIG. 12B illustrates an example of the consolidation information 1011. FIG. 12B illustrates an example of the consolidation information 1011, which the management unit 1004 of the information processing apparatus 101 has formed, by associating the detection history information 1009 and the purchase history information 1010, based on the product identification code 1101 of the cart 205.

As described above, the management unit 1004 of the information processing apparatus 101 stores the detection history information 1009 and the purchase history information 1010 including the product identification codes 1101 relevant to the same cart 205 in association with each other, as the consolidation information 1011.

Note that the cart 205 is repeatedly used many times, and therefore there may be cases where there are a plurality of items of detection history information 1009 or purchase history information 1010 including the product identification codes 1101 of the same cart 205. In this case, the management unit 1004 associates the detection history information 1009 and the purchase history information 1010 based on the information relevant to the time included in the detection history information 1009 and the information relevant to the time included in the purchase history information 1010. For example, the management unit 1004 may associate the detection history information 1009 and the purchase history information 1010, when the detection end time 1109 of the detection history information 1009 and the process time and date 1203 of the purchase history information 1010 are with a predetermined time period (for example, within five minutes).

The information processing apparatus 101 can provide various kinds of information such as the flow line of the cart 205, the staying time in each salesroom, etc., when the products included in the purchase history information 1010 are purchased, by analyzing the consolidation information 1011 as illustrated in FIG. 12B.

### <Process Flow>

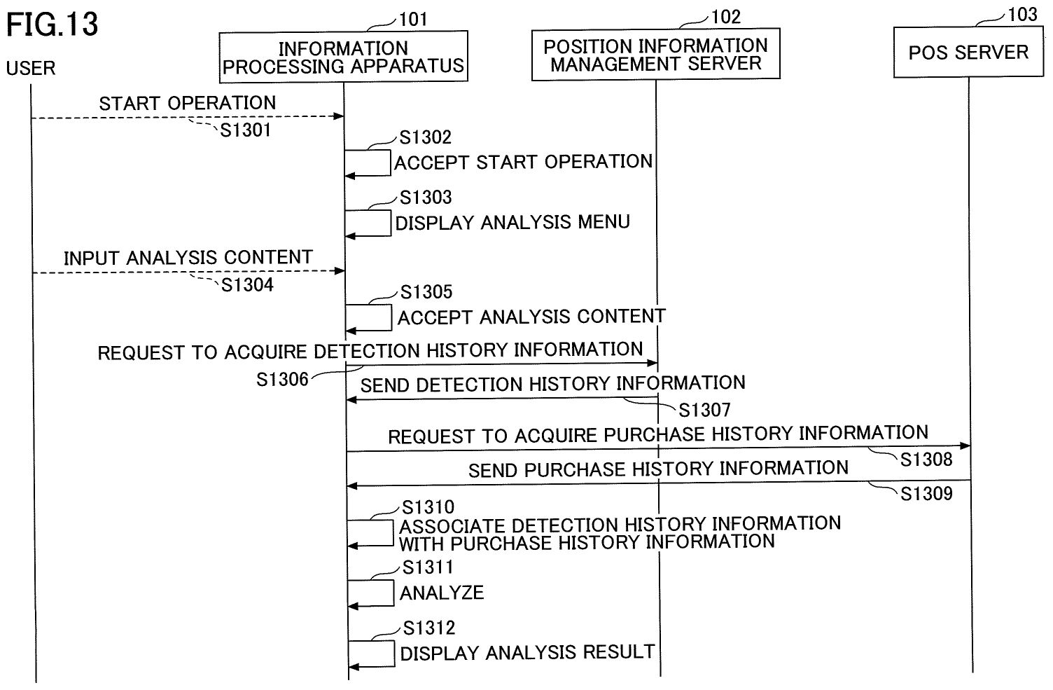

FIG. 13 is a sequence diagram of an example of a process by the information processing system 100 according to the first embodiment. Note that at the starting time point in FIG. 13, it is assumed that the detection history information 106 is stored in the position information management server 102, and the purchase history information 108 is stored in the POS server 103.

In step S1301, the user performs an operation to start an application corresponding to the information processing system 100 installed in the information processing apparatus 101, and in step S1302, the information processing apparatus 101 accepts the start operation by the user.

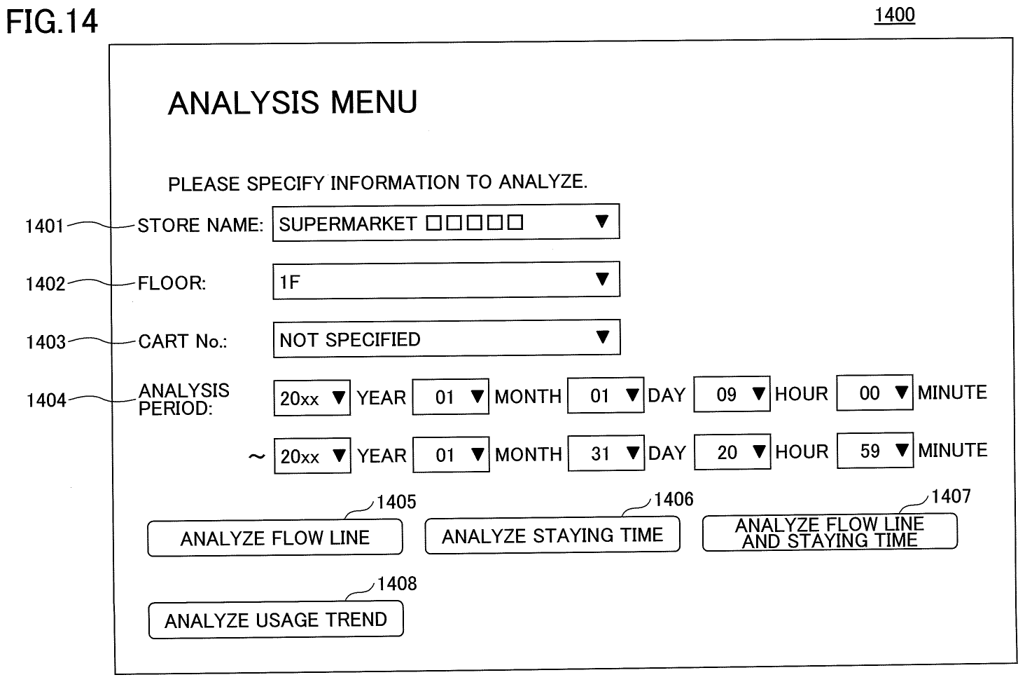

In step S1303, the display control unit 1006 of the information processing apparatus 101 that has accepted the start operation by the user causes the display input unit 1007 to display an analysis menu such that the items of the menu are selectable. An example of the displayed screen of the analysis menu is illustrated in FIG. 14.

FIG. 14 illustrates an example of a screen of an analysis menu according to the first embodiment. In an analysis menu screen 1400, for example, a store name 1401, a floor 1402, a “cart no.” 1403, an analysis period 1404, etc., are displayed in a selectable manner by a pull-down menu, etc.

Furthermore, in the analysis menu screen 1400, an “analyze flow line” button 1405, an “analyze staying time” button 1406, an “analyze flow line and staying time” button 1407, an “analyze usage trend” button 1408, etc., for specifying the analysis contents, are displayed.

Note that the analysis menu screen 1400 of FIG. 14 is merely one example.

Referring back to FIG. 13, the description of the sequence diagram is continued.

In step S1304, the user inputs an analysis content in the analysis menu screen 1400, and in step S1305, the information processing apparatus 101 accepts the input analysis content.

In step S1306, the first acquiring unit 1002 of the information processing apparatus 101 requests the position information management server 102 to acquire the detection history information.

In step S1307, the position information management unit 1014 of the position information management server 102, which has received the request to acquire the detection history information from the information processing apparatus 101, sends the requested detection history information to the information processing apparatus 101.

In step S1308, the second acquiring unit 1003 of the information processing apparatus 101 requests the POS server 103 to acquire the purchase history information. Note that this process may be executed before step S1306 or in parallel with step S1306.

In step S1309, the purchase information management unit 1017 of the POS server 103, which has received the request to acquire the purchase history information from the information processing apparatus 101, sends the requested purchase history information to the information processing apparatus 101.

In step S1310, the management unit 1004 of the information processing apparatus 101 associates the detection history information received from the position information management server 102 with the purchase history information received from the POS server 103, based on the product identification code 1101 of the cart 205. For example, the management unit 1004 of the information processing apparatus 101 associates the detection history information 1009 and the purchase history information 1010 including the product identification code of the same cart 205 with each other, and stores this information as consolidation information 1011 in the storage unit 1008.

In step S1311, the analysis unit 1005 of the information processing apparatus 101 performs predetermined analysis based on the analysis content accepted at step S1305.

In step S1312, the display control unit 1006 of the information processing apparatus 101 causes the display input unit 1007 to display the information analyzed by the analysis unit 1005.

Note that in the process of FIG. 13, it is assumed that the information processing apparatus 101 acquires the detection history information 1009 and the purchase history information 1010, according to the analysis content input by the user. Accordingly, for example, the information processing apparatus 101 is able to selectively acquire the detection history information 1009 needed for the analysis, from the detection history information 106 managed by the position information management server 102. Similarly, the information processing apparatus 101 is able to selectively acquire the purchase history information 1010 needed for the analysis, from the purchase history information 108 managed by the POS server 103.

However, this is merely one example, and the scope of the present invention is not so limited. For example, the information processing apparatus 101 may acquire the detection history information 1009 and the purchase history information 1010 and store this information in the storage unit 1008, in advance. Accordingly, even when the information processing apparatus 101 is in an off-line state, the information processing apparatus 101 is able to analyze various kinds of information.

### <Examples of Display Screens>

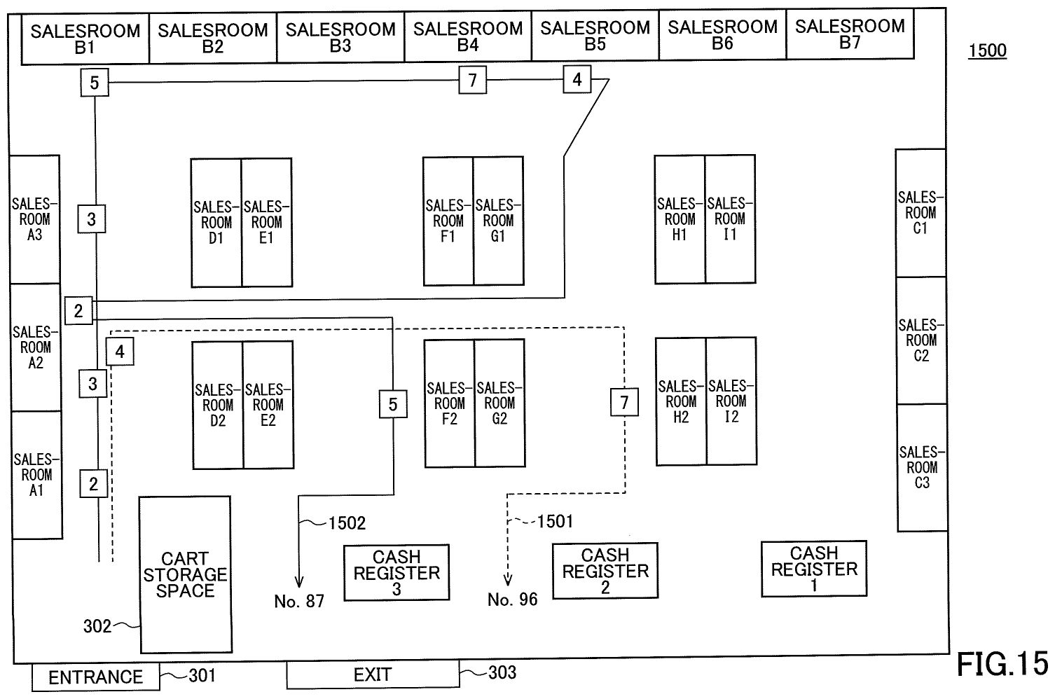

FIG. 15 illustrates an example of a display screen 1500 of analysis results according to the first embodiment. The screen of FIG. 15 is displayed when, for example, the “analyze flow line and staying time” button 1407 is selected in the analysis menu of FIG. 14. The display screen 1500 is an example in which the flow line and the staying time of each cart 205 are analyzed. In the example of FIG. 15, the flow line 1501 of the cart 205 of cart no. 96 is indicated by a dashed line, and the flow line 1502 of the cart 205 of cart no. 87 is indicated by a solid line.

Furthermore, the numbers displayed in squares along the flow lines indicate the staying time in units of minutes when the cart stays for more than a predetermined time (for example, one minute), in the area corresponding to each salesroom.

For example, in FIG. 15, it is seen that the cart of no. 96 has passed by the salesroom A1 within one minute, stayed in the salesroom A2 for four minutes, and then stayed in the salesroom H2 for seven minutes, and then moved toward the cash register 2. Accordingly, for example, it is possible to individually analyze the purchase behavior of a customer who has purchased a predetermined combination of products.

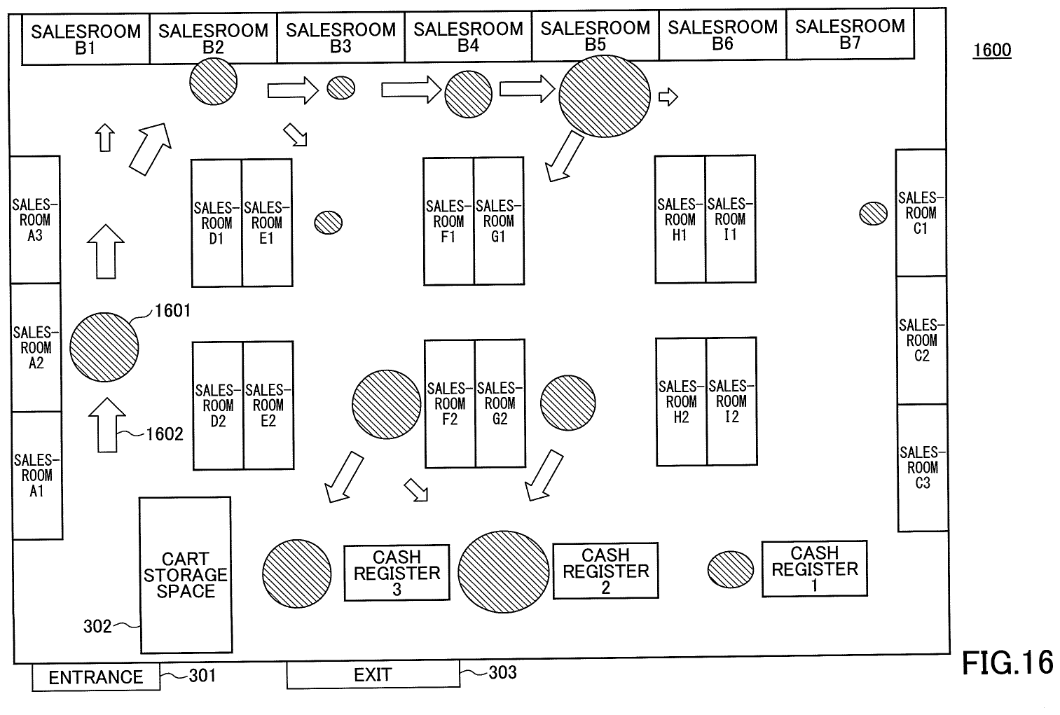

FIG. 16 illustrates another example of a display screen 1600 of analysis results according to the first embodiment. The screen of FIG. 16 is displayed when, for example, the “analyze usage trend” button 1408 is selected in the analysis menu of FIG. 14. The display screen 1600 is an example in which the usage trend in the salesroom is analyzed. In FIG. 16, the size of a circle 1601 indicates the number of carts 205 that have stayed in each salesroom for more than a predetermined time (for example, three minutes), within a predetermined period. As the circle becomes larger, it is indicated that more carts 205 have stayed. Furthermore, the size of the arrow 1602 indicates the number of carts 205 of more than a predetermined number (for example, 20) that have moved in the direction of the arrow, within a predetermined period. As the arrow becomes larger, it is indicated that more carts 205 have moved in the direction indicated by the arrow.

For example, in FIG. 16, it can be seen that many carts 205 are staying at the salesroom B5, the cash register 2, etc. On the other hand, it can be seen that no carts 205 are staying at the salesroom C2, the salesroom C3, the salesroom 12, etc., and that the cash register 1 is relatively vacant. Therefore, it can be determined that the salesrooms can be effectively used by placing a hot-selling product at the salesroom C2, the salesroom C3, etc.

As described above, the analysis unit 1005 is able to analyze, for example, the usage trends of salesrooms of the store 300, based on the detection history information 1009 of a plurality of carts and a plurality of items of purchase history information 1010.

### <Overview>

As described above, according to the present embodiment, it is possible to easily analyze the consumption trends of customers with the use of the existing POS system installed in a store, etc., while suppressing capital investment.

Furthermore, according to the present embodiment, it is possible to use any kind of information terminal (for example, a notebook PC, a tablet terminal, etc.) as the information processing apparatus 101 used for analysis, and perform the analysis at any location (for example, in a moving train, etc.).

### Second Embodiment

In a second embodiment, a description is given of an example where more detailed analysis is performed, by using the display information of products, storing the product identification codes of products displayed in the respective salesrooms, in addition to the configuration of the first embodiment.

### <Functional Configuration>

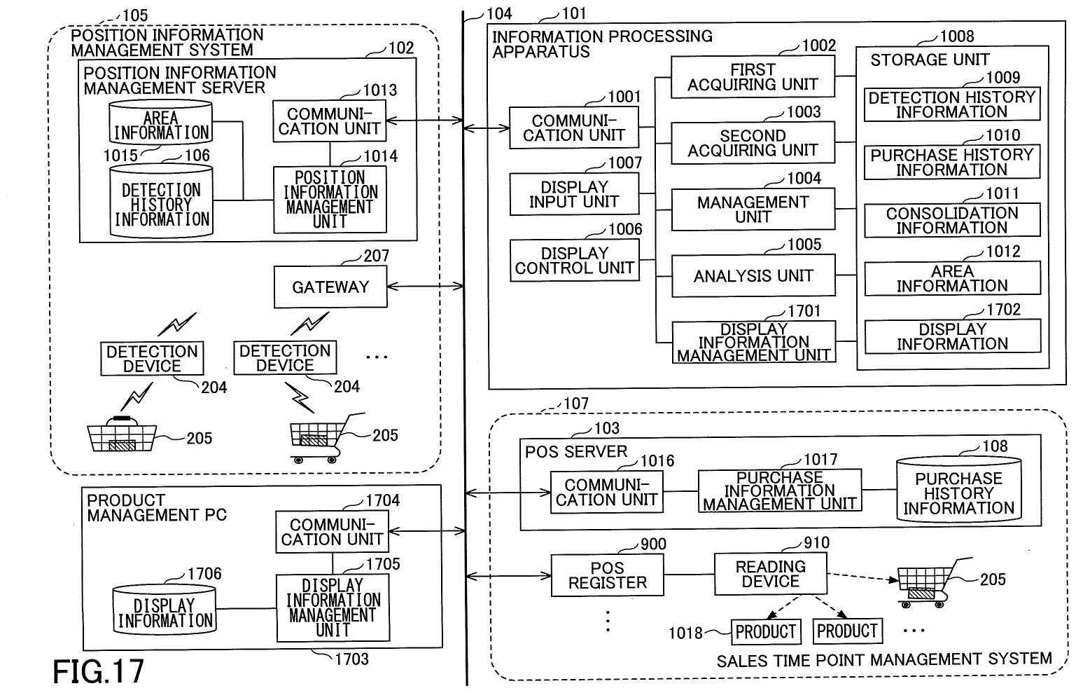

FIG. 17 a functional configuration of the information processing system 100 according to the second embodiment. The information processing system 100 according to the present embodiment includes a product management PC 1703, in addition to the configuration of the information processing system 100 according to the first embodiment illustrated in FIG. 1. Note that the configurations of the position information management server 102 and the POS server 103 are the same as those of the first embodiment.

(Functional Configuration of Information Processing Apparatus)

The information processing apparatus 101 according to the present embodiment includes a display information management unit 1701 in addition to the configuration of the information processing apparatus 101 according to the first embodiment illustrated in FIG. 10.

The display information management unit 1701 manages display information 1702, which is information for associating the salesroom of a store, etc., with a product identification code of a product displayed in the salesroom, by storing the display information 1702 in, for example, the storage unit 1008, etc.

For example, the display information management unit 1701 acquires the display information from the product management PC 1703, etc., managing display information 1706 of the store, etc., via the network 104, the recording medium 510, etc., and stores the display information as the display information 1702 in the storage unit 1008.

Alternatively, the display information management unit 1701 may cause the display input unit 1007 to display a management screen of display information, and store the input display information in the storage unit 1008.

Furthermore, in the present embodiment, the management unit 1004 adds the display information 1702 to the consolidation information 1011 according to the first embodiment, to create the consolidation information 1011.

(Functional Configuration of Product Management PC)

The product management PC 1703 has a hardware configuration of, for example, the computer 500 illustrated in FIG. 5, and realizes functions of a communication unit 1704, a display information management unit 1705, display information 1706, etc., by executing predetermined programs.

The communication unit 1704 is a unit for connecting the product management PC 1703 to the network 104, and performing transmission and reception of data with the information processing apparatus 101, etc. The communication unit 1704 is realized by, for example, the network I/F unit 505 of FIG. 5, programs operating in the CPU 501 of FIG. 5, etc.

The display information management unit 1705 is a unit for managing the display information 1706 in which the salesroom of a store, etc., and the product identification codes of products displayed in the salesroom are associated with each other. The display information management unit 1705 is realized by, for example, programs operating in the CPU 501 of FIG. 5, etc.

For example, the display information management unit 1705 accepts input of display information by an administrator of a store, and manages the accepted information as the display information 1706. The display information management unit 1705 provides part of or all of the display information 1706 to the information processing apparatus 101, in response to a request from the information processing apparatus 101, etc.

### <Examples of Information>

(Display Information)

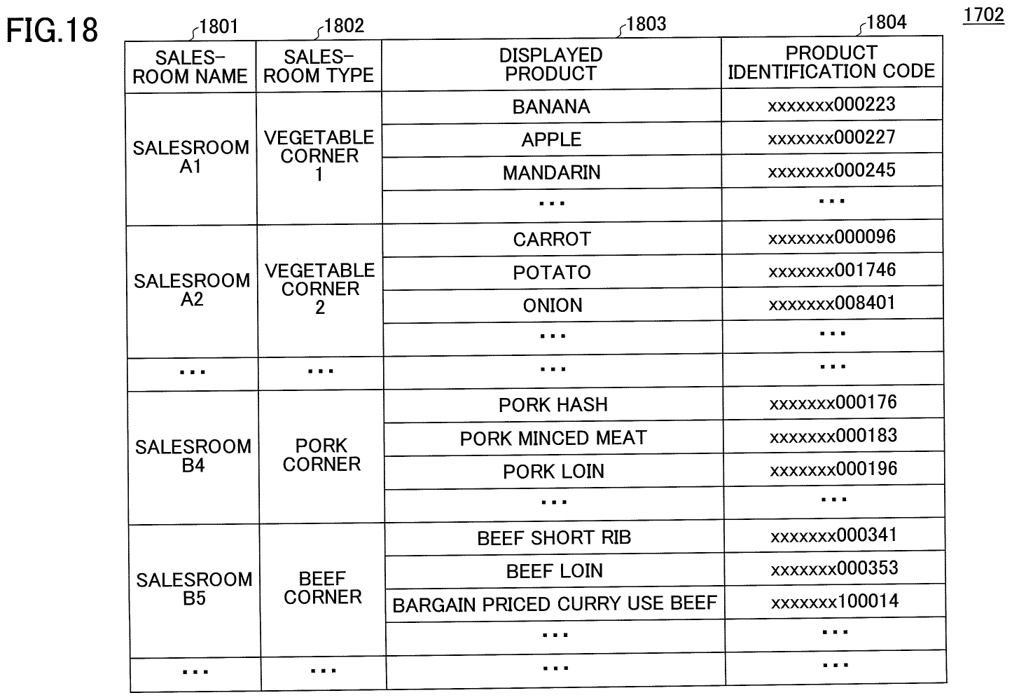

FIG. 18 illustrates an example of display information according to the second embodiment. In the example of FIG. 18, the display information 1702 includes information of a salesroom name 1801, a salesroom type 1802, a displayed product 1803, a product identification code 1804, etc.

The salesroom name 1801 is, for example, information that corresponds to the salesroom name in FIG. 3 (for example, salesroom A1, etc.), the area information of FIG. 11B, etc., and is information for identifying the salesroom.

The salesroom type 1802 is information indicating the type of the salesroom, etc., such as a vegetable corner, a pork corner, etc.

The displayed product 1803 is information indicating the name of the product displayed in the salesroom.

The product identification code 1804 is identification information such as a JAN code, etc., for identifying a plurality of products displayed in a salesroom.

Note that the display information of FIG. 18 is one example. In the present embodiment, the display information 1702 may be any information by which the salesroom name 1801 and the product displayed in an area, etc., corresponding to the salesroom name 1801 can be identified, based on the product identification code 1804.

(Consolidation Information)

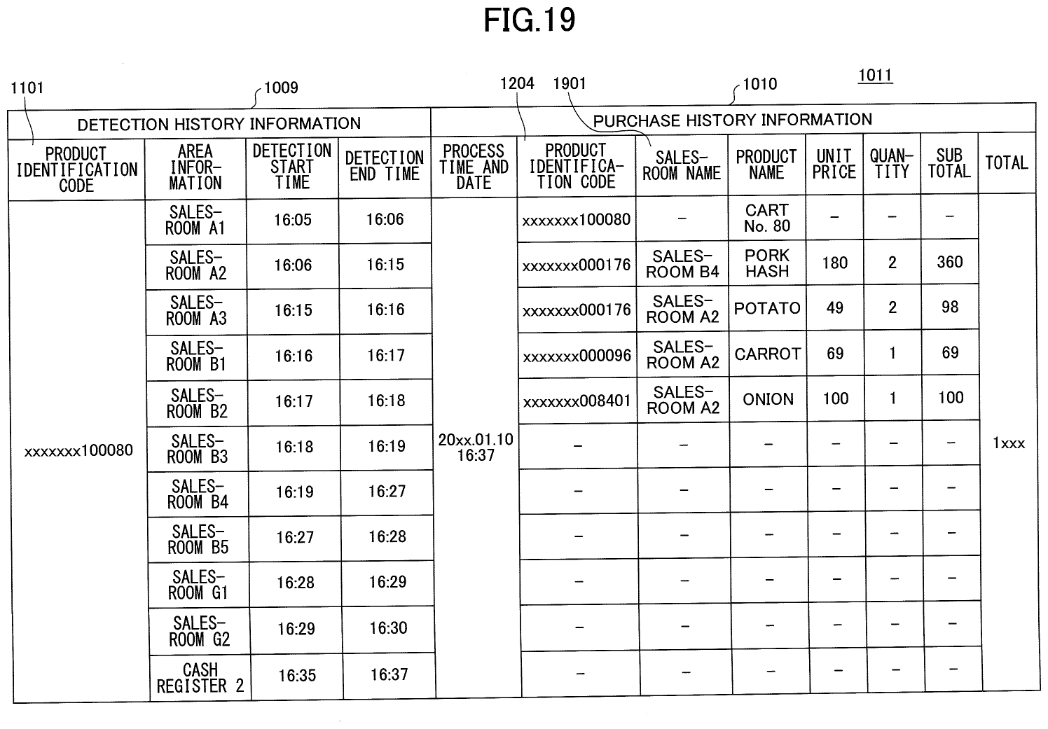

FIG. 19 illustrates an example of the consolidation information 1011 according to the second embodiment. The consolidation information 1011 according to the present embodiment includes information of a salesroom name 1901, in addition to the consolidation information 1011 illustrated in FIG. 12.

The salesroom name 1901 is information indicating the name of the salesroom in which the products are displayed, and the salesroom name 1901 is generated based on the display information 1702. For example, “onion” having the product identification code 1204 of “xxxxxxx008401” included in the consolidation information 1011 of FIG. 19, can be identified as being displayed in the salesroom having the salesroom name 1801 “salesroom A2”, based on the product identification code 1804 in the display information of FIG. 18. The information processing apparatus 101 is also able to manage where each product is displayed, based on the information of the salesroom name 1901.

### <Example of Display Screen>

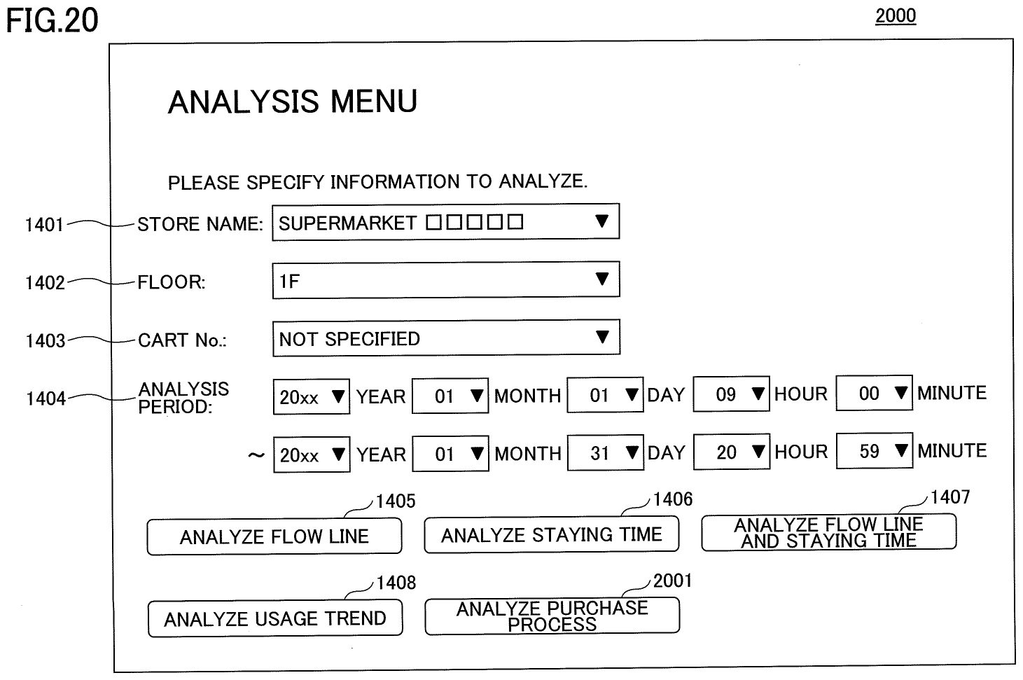

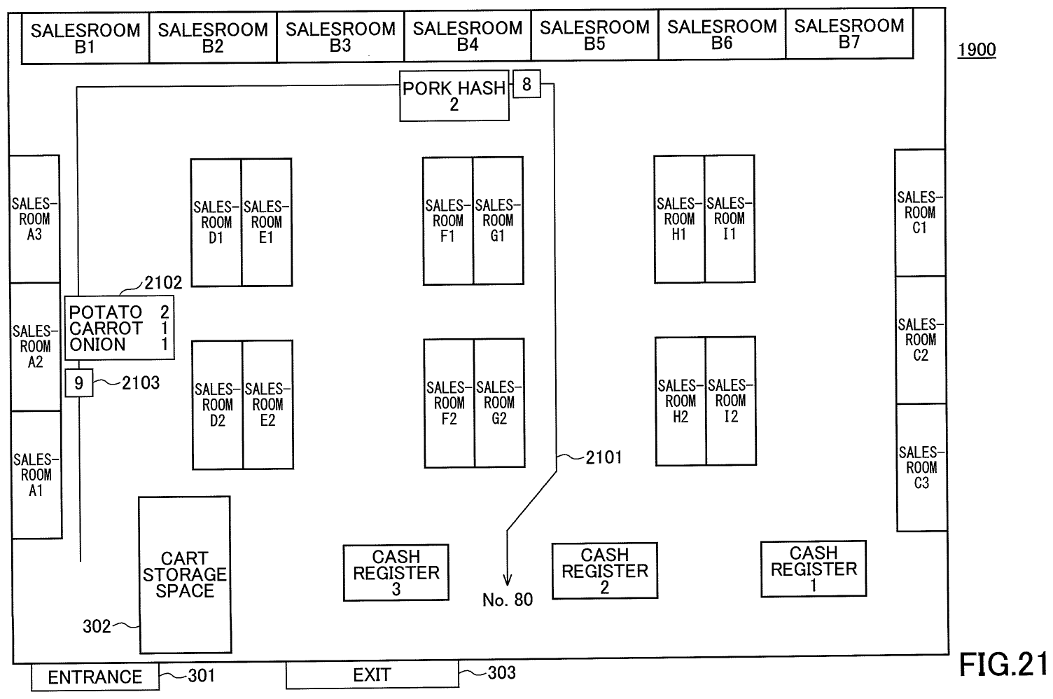

FIG. 20 illustrates an example of a screen of an analysis menu according to the second embodiment. An analysis menu 2000 according to the present embodiment includes, for example, a “analyze purchase process” button 2001 in addition to the analysis menu according to the first embodiment illustrated in FIG. 14. An example of the display screen of the analysis result obtained by the analysis by selecting this button, is illustrated in FIG. 21.

FIG. 21 illustrates an example of a display screen 1900 of an analysis result according to the second embodiment. In the example of FIG. 21, information of products 2102 purchased at each salesroom is displayed, in addition to a flow line 2101 of the cart 205 having a cart no. 80 and information of the staying time 2103 displayed in squares along the flow line.

Accordingly, for example, it is possible to analyze information indicating the next salesroom to which a customer, who purchased a product in the salesroom A2 has, moved, the product that this customer has purchased next, etc. Furthermore, it is possible to easily obtain information indicating the staying time at a particular salesroom when purchasing a product in the salesroom.

Furthermore, for example, as in the case of the cart 205 having the cart no. 87 in FIG. 15, when a flow line of returning to the salesroom A2 from the salesroom B5 is generated, it is possible to analyze what the customer has purchased at the salesroom B2, and what the customer has purchased in the salesroom A2 after returning to the salesroom A2. For example, if it is known that a customer has purchased beef of “bargain priced curry use beef” at the salesroom B5, and this customer returned to the salesroom A2 and has purchased “carrots”, “potatoes”, and “onions”, it is possible to revise the arrangement of salesrooms, and make an announcement, etc., to the customer by posting a notice indicating bargain information near the entrance.

Furthermore, for example, in the analysis screen of usage trends as illustrated in FIG. 16, it is possible to display information such as the name and the quantity of the product that selling well at a salesroom where many customers are staying, and therefore it is possible to analyze more detailed usage trends.

### <Overview>

As described above, by the information processing apparatus 101 according to the present embodiment, by managing the salesrooms and the display information 1702 including information of the products displayed in each salesroom, it is possible to analyze more detailed consumption trends of customers.

### Third Embodiment

In the first and second embodiments, a description is given of the position information management system 105 that manages the detection history information 106 based on the product identification code sent by the transmitting device 206 provided in the cart 205, etc.

In the present embodiment, a description is given of the position information management system 105 that manages the detection history information, by using a more widely spread information terminal such as a smartphone, etc. Accordingly, even in a store that is not provided with carts 205, etc., the present invention can be applied.

### <System Configuration>

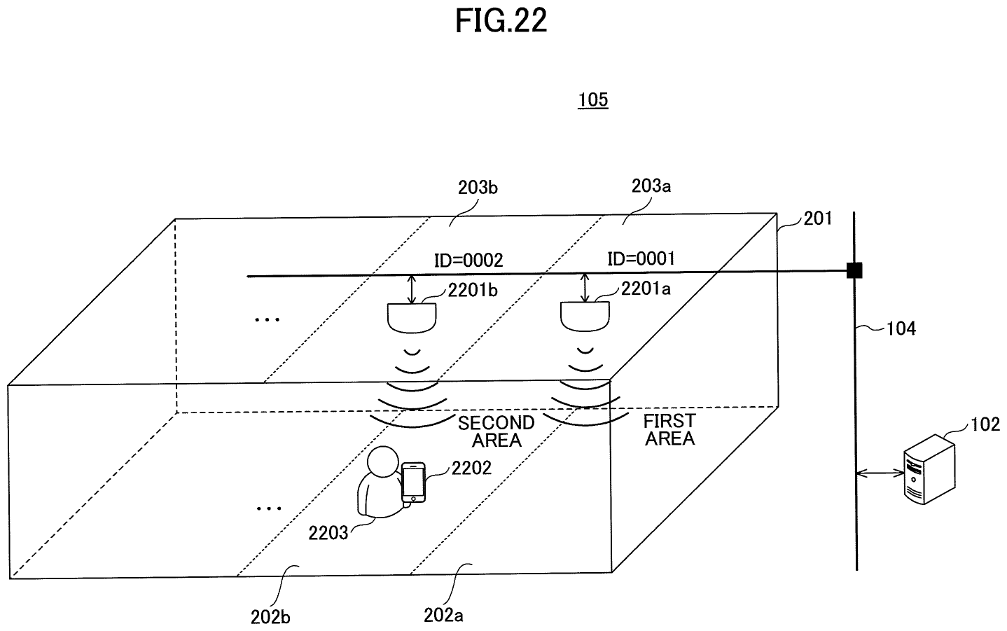

FIG. 22 illustrates an example of a configuration of the position information management system 105 according to the third embodiment. The position information management system 105 according to the present embodiment includes the position information management server 102, a plurality of transmitting devices 2201a, 2201b, and an information terminal 2202 held by a user 2203, etc.

The plurality of transmitting devices 2201a, 2201b are respectively provided on, for example, ceilings 203a, 203b, etc., which respectively correspond to a plurality of areas 202a, 202b specified in advance by dividing the area inside a store 201, etc. Note that in the following description, any one of the plurality of transmitting devices 2201a, 2201b is indicated as a “transmitting device 2201”. Furthermore, the number of transmitting devices 2201 in FIG. 22 is one example; the number of transmitting devices 2201 may be any number of two or more.

The plurality of transmitting devices 2201a, 2201b respectively output sound waves including a device ID (fourth identification information) that is identification of each own device. For example, in the example of FIG. 22, the transmitting device 2201a outputs a sound wave including a device ID “0001” corresponding to the area 202a, and the transmitting device 2201b outputs a sound wave including a device ID “0002” corresponding to the area 202b. This information corresponds to, for example, the identification information of the detection device 204 according to the first embodiment illustrated in FIG. 3.

The transmitting device 2201 is preferably communicatively connected to the position information management server 102 via the network 104, and the transmitting device 2201 is able to output sound waves, for example, including the device ID reported from the position information management server 102. Alternatively, the transmitting device 2201 may output sound waves including the device ID of the own device stored in advance. Note that the transmitting device 2201 may have a configuration of communicating with the position information management server 102 via the gateway 207, similar to the detection device 204 according to the first embodiment illustrated in FIG. 2.

The information terminal 2202 is an information device such as a smartphone, a tablet terminal, etc., held by the user 2203 of the store, etc., and an application corresponding to the information processing system 100 is installed in the information terminal 2202.

The information terminal 2202 includes a product identification code (JAN code, etc.) provided by application, etc., corresponding to the information processing system 100, and can display the product identification code on a display unit according to a predetermined operation.

Note that the product identification code provided by the application may be, for example, randomly generated by the application, or may be generated by the application based on the telephone number or the individual identification code of the information terminal 2202, or the time, etc.

Furthermore, the information terminal 2202 extracts a device ID included in the sound wave, when a microphone, etc., provided in the information terminal 2202 detects a predetermined sound wave output from the transmitting device 2201. Furthermore, the information terminal 2202 sends the extracted device ID and the product identification code of the information terminal 2202, to the position information management server 102.

The position information management server 102 identifies the area in which the information terminal 2202 is positioned, based on the area information 1015 indicating the relationship between identification information of the salesrooms of the store, etc., and the areas as illustrated in FIG. 3, the device ID received from the information terminal 2202, and the product identification code relevant to the information terminal 2202.

Furthermore, in the present embodiment, when the reading device 910 of the POS register 900 reads the product identification code (JAN code, etc.) of the product 1018, the reading device 910 reads the product identification code relevant to the information terminal 2202 displayed on a display unit of the information terminal 2202.

Accordingly, in the present embodiment, it is possible to manage the detection history information 106 and the purchase history information 108 relevant to the information terminal 2202 in association with each other, based on the product identification code displayed by the information terminal 2202 held by a user in the store, etc., instead of the cart 205.

### <Hardware Configuration>

(Hardware Configuration of Transmitting Device)

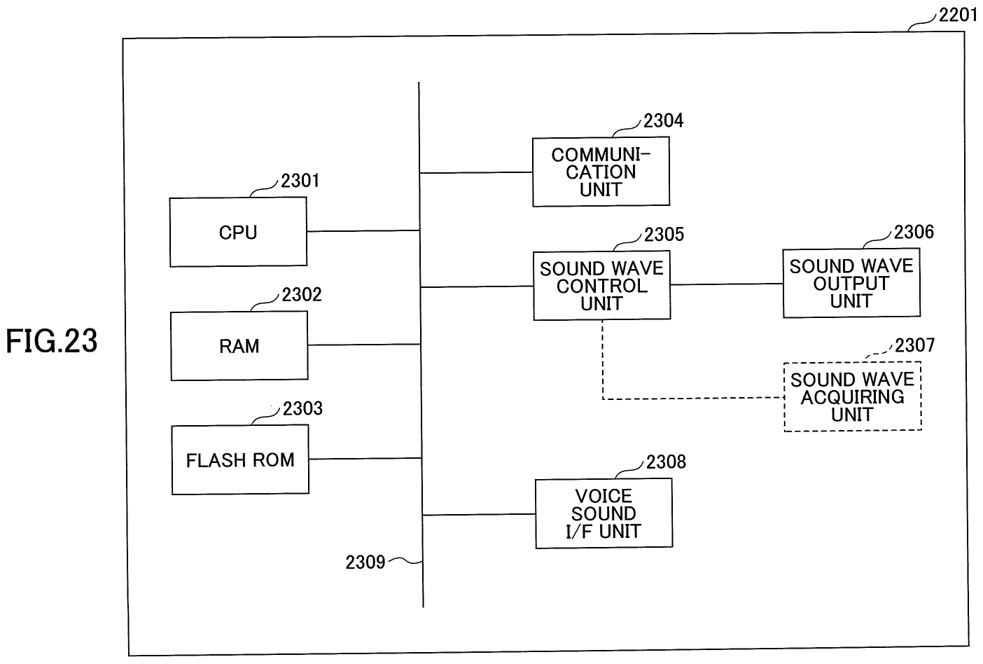

FIG. 23 illustrates an example of a hardware configuration of the transmitting device 2201 according to the third embodiment. The transmitting device 2201 includes, for example, a CPU 2301, a RAM 2302, a flash ROM 2303, a communication unit 2304, a sound wave control unit 2305, a sound wave output unit 2306, a voice sound I/F unit 2308, a bus 2309, etc. Furthermore, the transmitting device 2201 may include a sound wave acquiring unit 2307.

The CPU 2301 is an arithmetic device for implementing various functions of the transmitting device 2201, by executing programs stored in the flash ROM 2303, etc. The RAM 2302 is a volatile memory used as a work area, etc., of the CPU 2301. The flash ROM 2303 is a non-volatile memory for storing programs, individual information such as a device ID, etc., of the transmitting device 2201.

The communication unit 2304 is a communication interface for connecting the transmitting device 2201 to the network 104. Note that the communication unit 2304 may be a wireless communication interface for performing wireless communication with the gateway 207, when the position information management system 105 includes the gateway 207 according to the first embodiment illustrated in FIG. 2.

The sound wave control unit 2305 converts the device ID, etc., stored in the flash ROM 2303 into sound wave signals, and outputs the converted device ID to the sound wave output unit 2306.

Preferably, the sound wave control unit 2305 outputs the device ID, etc., by using a high frequency of, for example, greater than or equal to 16 kHz, in the voice sound frequency band. The sound waves have a higher directivity as the frequency becomes higher, and a frequency of greater than or equal to 16 kHz can barely be heard by a human being, and is thus preferable for sending a device ID, etc. Furthermore, the sound wave control unit 2305 may output the device ID, etc., to the sound wave output unit 2306, by superimposing the device ID on an announcement input from the voice sound I/F unit 2308, or voice sound signals such as music.

Note that in the present embodiment, the specific method of transferring data by sound waves is not particularly limited; however, for example, information may be transmitted by modulating the sound waves of a predetermined frequency, by a known method such as FSK (Frequency Shift Keying), PSK (Phase Shift Keying), etc.

The sound wave output unit 2306 includes an electric sound conversion apparatus such as a speaker, etc., for converting sound wave signals input from the sound wave control unit 2305 into sound waves, and outputting the sound waves.

The voice sound I/F unit 2308 is an interface for inputting voice sound signals such as an announcement, music, etc.; however, the transmitting device 2201 does not need to include the voice sound I/F unit 2308.

The bus 2309 is connected to the respective elements described above, and transmits address signals, data signals, various control signals, etc.

(Hardware Configuration of Information Terminal)

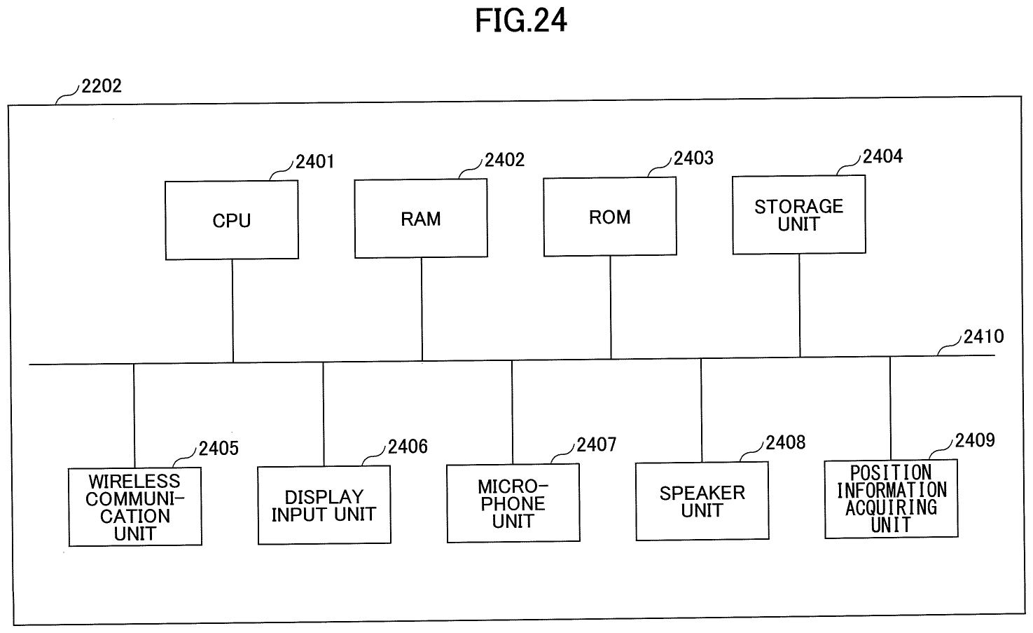

FIG. 24 illustrates an example of a hardware configuration of the information terminal 2202 according to the third embodiment. The information terminal 2202 has a configuration of a general computer, and includes, for example, a CPU 2401, a RAM 2402, a ROM 2403, a storage unit 2404, a wireless communication unit 2405, a display input unit 2406, a microphone unit 2407, a speaker unit 2408, a position information acquiring unit 2409, a bus 2410, etc.

The CPU 2401 is an arithmetic device for implementing various functions of the information terminal 2202, by loading the programs and data stored in the ROM 2403, the storage unit 2404, etc., into the RAM 2402, and executing processes. The RAM 2402 is a volatile memory used as a work area, etc., of the CPU 2401. The ROM 2403 is a non-volatile memory for holding programs and data even after the power is turned off.

The storage unit 2404 is a storage device such as SSD, a flash ROM, etc., and stores an OS, an application program, various kinds of data, etc.

The wireless communication unit 2405 is a communication interface corresponding to a communication method such as a mobile communication network including 3G (3rd. Generation), LTE (Long Term Evolution), etc., or wireless LAN communication, etc. The information terminal 2202 transmits and receives data with the position information management server 102, etc., via the wireless communication unit 2405, by connecting to the network 104.

The display input unit 2406 displays a display screen according to a program, etc., executed by the information terminal 2202, and accepts an input operation by the user 2203. For example, the display input unit 2406 is a display input device such as a touch panel display, etc.

The microphone unit 2407 includes an element for electric sound conversion such as a microphone, etc., and converts the acquired sound waves into sound wave signals, and further converts the sound wave signals into sound wave data having a predetermined format. A microphone that is included in a smartphone, etc., in recent years is able to collect the sound waves of 20 kHz, more preferably approximately 24 kHz. Therefore, the microphone unit 2407 can appropriately acquire sound waves in a high frequency of greater than or equal to 16 kHz output from the transmitting device 2201. As described above, the “sound waves” in the present embodiment may include ultrasound waves of greater than or equal to 20 kHz.

The speaker unit 2408 includes an element for electric sound conversion such as a speaker, etc., and converts the sound wave data into sound wave signals, and further converts the sound wave signals into sound waves and outputs the sound waves by a speaker, etc.

The position information acquiring unit 2409 is a position information acquiring device such as a GPS (Global Positioning System) receiving device, etc., for acquiring the position information of the information terminal 2202.

The bus 2410 is connected to the respective elements described above, and transmits address signals, data signals, various control signals, etc.

Note that the information terminal 2202 is able to execute a predetermined program by installing, in the information terminal 2202, an application program downloaded via the wireless communication unit 2405. For example, the information terminal 2202 can download and install an application corresponding to the information processing system 100, and execute the application.

### <Functional Configuration>

Here, a description is given of a functional configuration of the position information management system 105 according to the present embodiment. Note that the configurations of the information processing apparatus 101, the sales time point management system 107, etc., are the same as those of the first and second embodiments.

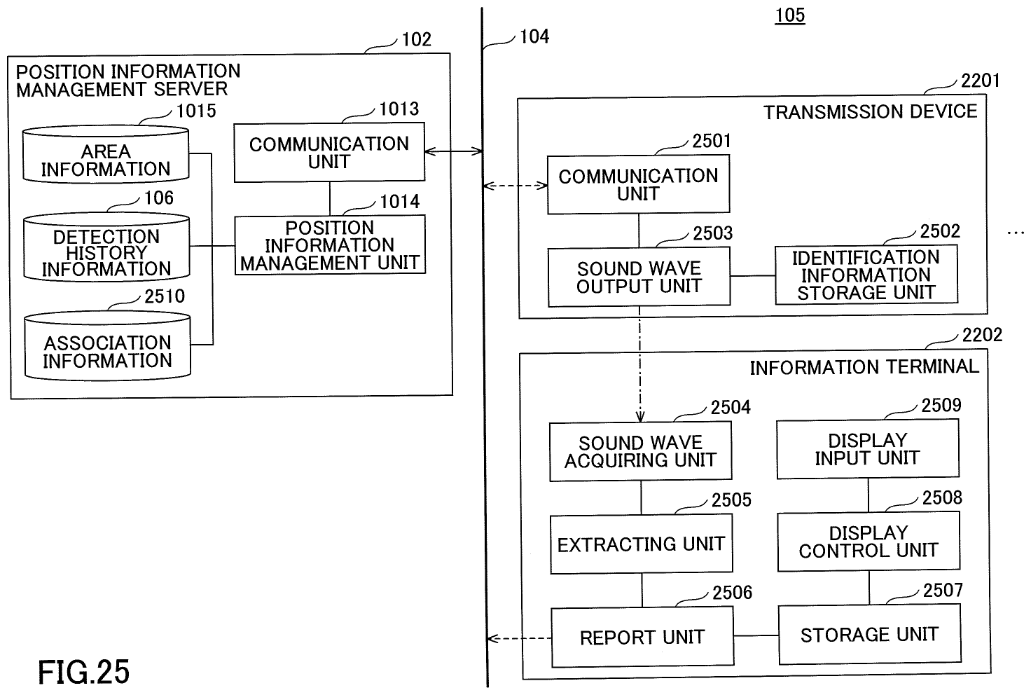

FIG. 25 illustrates a functional configuration of the position information management system 105 according to the third embodiment. The position information management system 105 includes the transmitting device 2201, the information terminal 2202, and the position information management server 102.

(Functional Configuration of Transmitting Device)

The transmitting device 2201 includes a communication unit 2501, a sound wave output unit 2503, and an identification information storage unit 2502.

The communication unit 2501 is a unit for connecting the transmitting device 2201 to the network 104, and transmitting and receiving data with the position information management server 102, etc. The communication unit 2501 is realized by, for example, the communication unit 2304 of FIG. 23, programs operating in the CPU 2301 of FIG. 23, etc. Note that the transmitting device 2201 does not need to include the communication unit 2501.

The identification information storage unit 2502 is a unit for storing the identification information (hereinafter, “device ID”) of the transmitting device 2201, and is realized by, for example, the flash ROM 2303, etc., of FIG. 23, etc.

The sound wave output unit 2503 is a unit for generating and outputting sound waves including the device ID (fourth identification information) of the transmitting device 2201, and is realized by, for example, the sound wave control unit 2305, the sound wave output unit 2306 of FIG. 23, and programs operating in the CPU 2301 of FIG. 23, etc.

(Functional Configuration of Information Terminal)

The information terminal 2202 includes a sound wave acquiring unit 2504, an extracting unit 2505, a report unit 2506, a storage unit 2507, a display control unit 2508, and a display input unit 2509.

The sound wave acquiring unit 2504 is a unit for acquiring sound waves output from the transmitting device 2201, and is realized by, for example, the microphone unit 2407 of FIG. 24, programs operating in the CPU 2401 of FIG. 24, etc.

The extracting unit 2505 is a unit for extracting the device ID of the transmitting device 2201 included in the sound waves acquired by the sound wave acquiring unit 2504, and is realized by, for example, programs operating in the CPU 2401 of FIG. 24, etc.

The report unit 2506 reports the device ID extracted by the extracting unit 2505 and the product identification code relevant to the information terminal 2202, to the position information management server 102.

Preferably, the report unit 2506 sends the extracted device ID, the product identification code relevant to the information terminal 2202, and information (date or time, etc.) relevant to the time when the device ID is extracted, to the position information management server 102.

Furthermore, in another example, the report unit 2506 may sequentially store the extracted device ID and the information relevant to time when the device ID is extracted, in the storage unit 2507, and collectively send the stored plurality of items of information to the position information management server 102.

The storage unit 2507 is a unit for storing, for example, the extracted device ID, the information of the time when the device ID is extracted, the product identification code of the information terminal 2202, etc., and is realized by, for example, the storage unit 2404 of FIG. 24.

The display control unit 2508 is a unit for causing the display input unit 2509 to display, for example, the product identification code of the information terminal 2202, in response to a predetermined operation with respect to the display input unit 2509, and is realized by, for example, programs operating in the CPU 2401 of FIG. 24, etc.

The display input unit 2509 displays the product identification code relevant to the information terminal 2202, according to the control of the display control unit 2508. Furthermore, the display input unit 2509 accepts an operation by the user. The display input unit 2509 is realized by, for example, the display input unit 2406 of FIG. 24, programs operating in the CPU 2401 of FIG. 24, etc.

(Functional Configuration of Position Information Management Server)

The position information management server 102 according to the third embodiment includes association information 2510, in addition to the functional configuration of the position information management server 102 according to the first embodiment illustrated in FIG. 10.

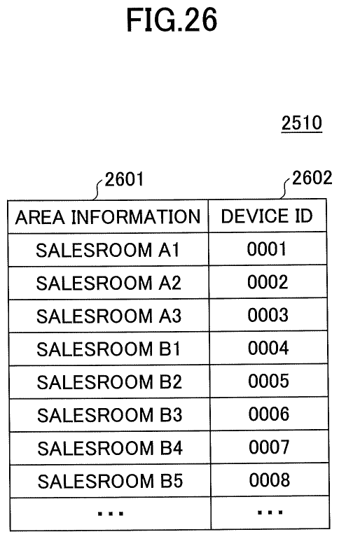

FIG. 26 illustrates an example of the association information 2510 according to the third embodiment. In the example of FIG. 26, the association information 2510 stores area information 2601 and a device ID 2602 in association with each other.

The area information 2601 is, for example, information indicating the areas obtained by dividing the floor of the store 300 into a plurality of areas as illustrated in FIG. 3. For example, the area information 2601 is indicated by a salesroom name (salesroom A1, etc.) and an area name (1st area, etc.). In the example of FIG. 26, salesroom names are stored as the area information 2601.

The device ID 2602 is a device ID of the transmitting device 2201 arranged in the area. Accordingly, for example, when the information terminal 2202 detects a device ID 2602 “0001”, it can be identified that the information terminal 2202 is positioned in the “salesroom A1”.

The position information management unit 1014 of the position information management server 102 according to the present embodiment manages the detection history information 106, based on the information reported from the information terminal 2202, that is, the product identification code of the information terminal 2202, the device ID, and time information. For example, the position information management unit 1014 identifies the information of the area where the information terminal 2202 is positioned, based on the device ID of the transmitting device 2201 reported from the information terminal 2202 and the association information 2510. Furthermore, the position information management unit 1014 stores the information of the area where the information terminal 2202 is positioned (salesroom name, area name, identification information of the detection device 204, etc.,) and the information relevant to the time (date, time, etc.), in association with the product identification code relevant to the information terminal 2202, in the detection history information 106.

### <Process Flow>

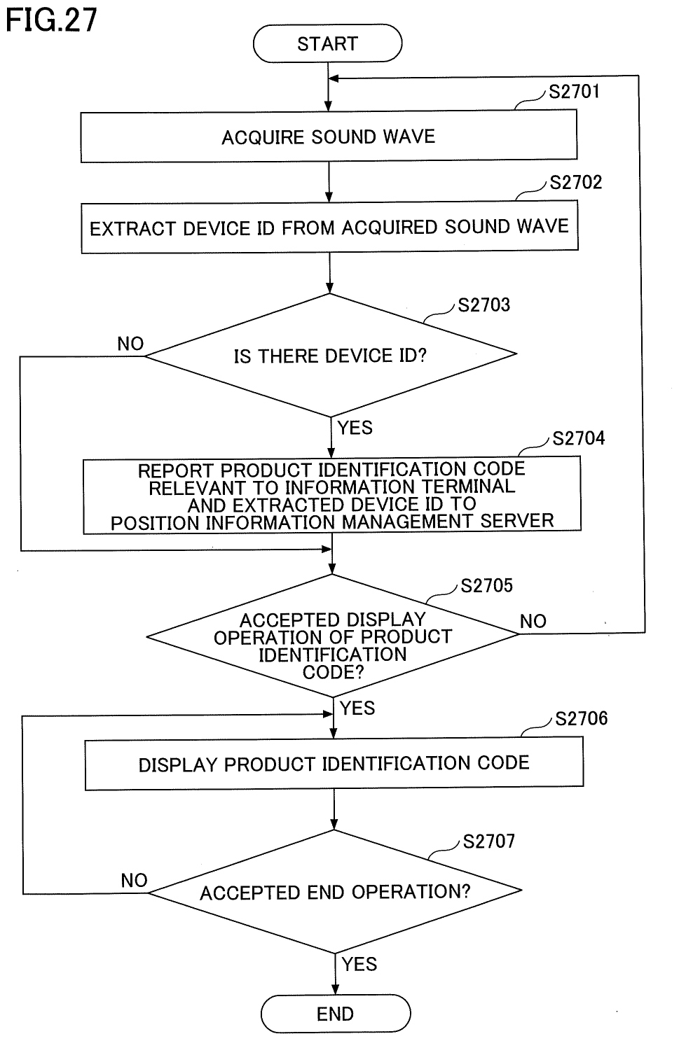

FIG. 27 is a flowchart of an example of a process by the information terminal 2202 according to the third embodiment.

For example, when an application corresponding to the information processing system 100 is activated at the information terminal 2202, in step S2701, the sound wave acquiring unit 2504 acquires sound waves surrounding the information terminal 2202.

In step S2702, the extracting unit 2505 of the information terminal 2202 extracts the device ID included in the acquired sound waves.

In step S2703, the information terminal 2202 shifts the process to step S2704 when the device ID is included in the acquired sound waves, and shifts the process to step S2705 when the device ID is not included in the acquired sound waves.

When the process shifts to step S2704, the report unit 2506 reports the product identification code relevant to the information terminal 2202 and the device ID extracted by the extracting unit 2505, to the position information management server 102. At this time, the information reported to the position information management server 102 may include the information (date or time, etc.) relevant to the time when the information terminal 2202 has detected the device ID.

When the process shifts to step S2705, the information terminal 2202 determines whether an operation to display the product identification code is accepted from the user 2203. Note that the operation to display the product identification code is performed when the product identification code is read by the reading device 910 of the POS register 900 when the user 2203 checks out at the cash register.

In step S2705, when the operation to display the product identification code is not accepted, the information terminal 2202 shifts the process to step S2701 and repeats the same process. On the other hand, when the operation to display the product identification code is accepted, the information terminal 2202 shifts the process to step S2706.

When the process shifts to step S2706, the display control unit 2508 of the information terminal 2202 causes the display input unit 2509 to display the product identification code relevant to the information terminal 2202.

In step S2707, for example, the display control unit 2508 of the information terminal 2202 continues to display the product identification code until an end operation is accepted from the user 2203, and the display control unit 2508 ends the process when the end operation is accepted.

Note that the process of FIG. 27 is one example. For example, the report unit 2506 may sequentially store a plurality of device IDs extracted by the extracting unit 2505 together with information relevant to the time when the device ID is detected, and collectively send the stored information to the position information management server 102.

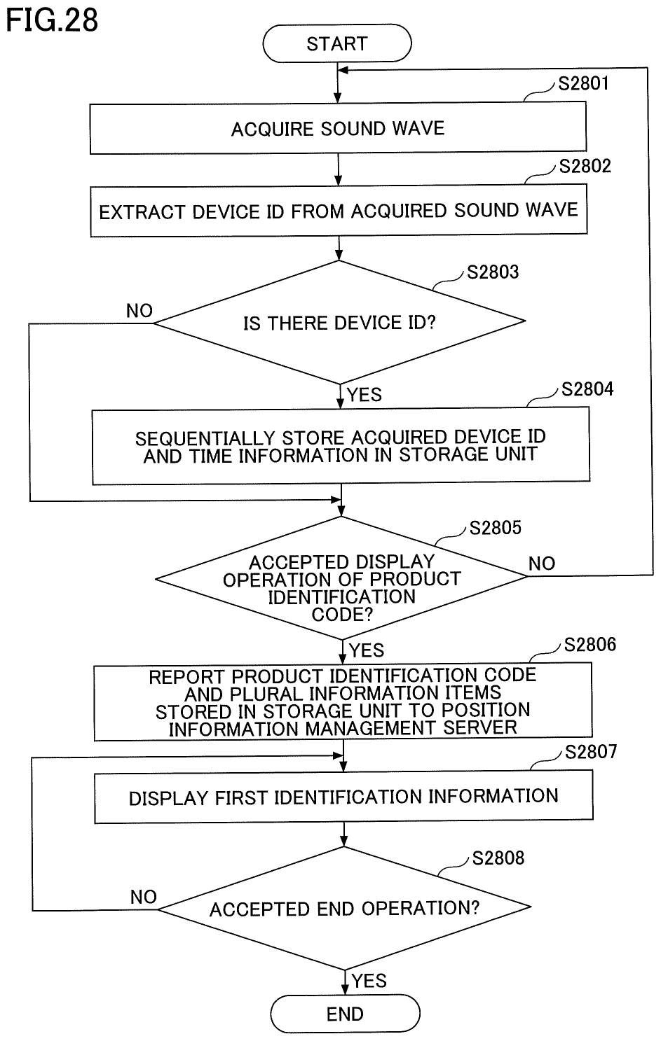

FIG. 28 is a flowchart of another example of a process by the information terminal 2202 according to the third embodiment.

For example, when an application corresponding to the information processing system 100 is activated at the information terminal 2202, in step S2801, the sound wave acquiring unit 2504 acquires sound waves surrounding the information terminal 2202.

In step S2802, the extracting unit 2505 of the information terminal 2202 extracts the device ID included in the acquired sound waves.

In step S2803, the information terminal 2202 shifts the process to step S2804 when the device ID is included in the acquired sound waves, and shifts the process to step S2805 when the device ID is not included in the acquired sound waves.

When the process shifts to step S2804, the report unit 2506 stores the acquired device ID together with information relevant to the time when the device ID is extracted, in the storage unit 2507.

When the process shifts to step S2805, the information terminal 2202 determines whether an operation to display the product identification code is accepted from the user 2203. Note that the operation to display the product identification code is performed when the product identification code is read by the reading device 910 of the POS register 900 when the user 2203 checks out at the cash register.

In step S2805, when the operation to display the product identification code is not accepted, the information terminal 2202 shifts the process to step S2801 and repeats the same process. On the other hand, when the operation to display the product identification code is accepted, the information terminal 2202 shifts the process to step S2806.

When the process shifts to step S2806, the report unit 2506 of the information terminal 2202 sends the plurality of device ID and the information relevant to the time when the device ID is extracted stored in the storage unit 2507, and the product identification code (JAN code, etc.) of the information terminal 2202, to the position information management server 102. Note that the report unit 2506 may report the above information to the position information management server 102 at a different timing form step S2806 (for example, after the end operation is accepted at step S2808, etc.).

In step S2807, the display control unit 2508 of the information terminal 2202 causes the display input unit 2509 to display the product identification code of the information terminal 2202.

In step S2808, for example, the display control unit 2508 of the information terminal 2202 continues to display the product identification code until an end operation is accepted from the user 2203, and the display control unit 2508 ends the process when the end operation is accepted.

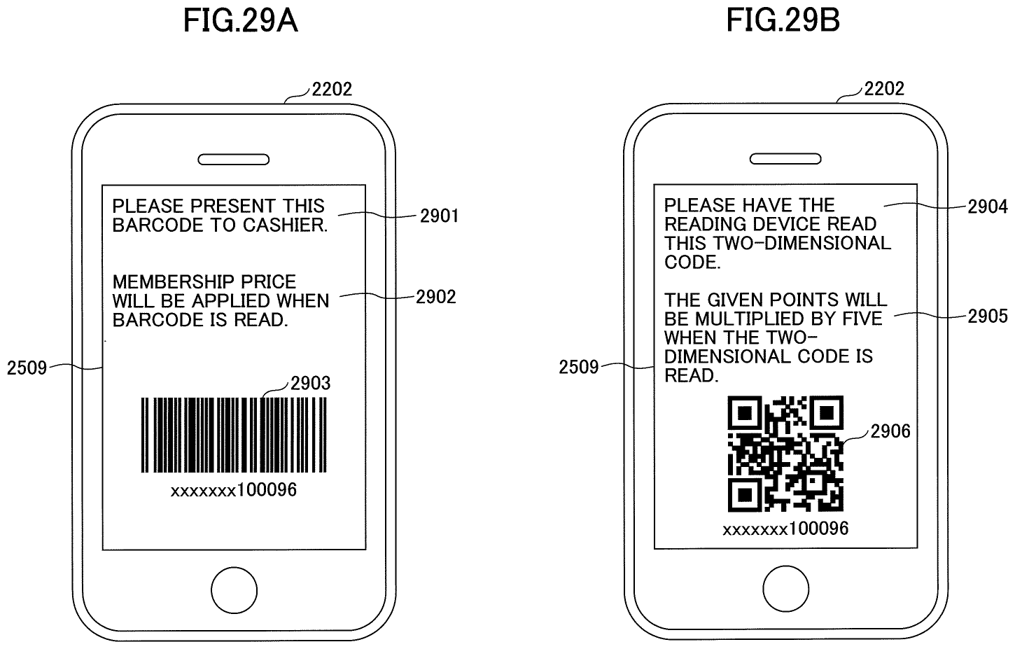

The display screen that is displayed on the display input unit 2509 at step S2807 is illustrated in FIGS. 29A and 29B.

FIGS. 29A and 29B illustrate examples of display screens of the information terminal 2202 according to the third embodiment.

In the example of FIG. 29A, the display screen displayed on the display input unit 2509 of the information terminal 2202 includes a barcode 2903 corresponding to the product identification code (JAN code, etc.), and a message 2901, etc., prompting to present the barcode 2903 to the cashier.

Preferably, this display screen also includes a message 2902, etc., indicating information of the benefits that can be obtained by presenting the barcode. By displaying the message 2902 indicating information of the benefits, the barcode can be presented by more users.

In the example of FIG. 29B, the display screen displayed on the display input unit 2509 of the information terminal 2202 includes a two-dimensional code 2906 including the product identification code (JAN code, etc.), and a message 2904, etc., prompting to have the two-dimensional code 2906 read by the reading device 910.

Preferably, this display screen also includes a message 2905, etc., indicating information of the benefits that can be obtained by presenting the two-dimensional code 2906.

As described above, the display control unit 2508 is preferably able to display the product identification code in various formats according to the POS system installed in the store, etc.

By the above processes, the position information management server 102 according to the present embodiment is able to acquire the detection history information 106, similar to the first and second embodiments.

Note that the above system configuration is one example, and various applications may be made. For example, the first acquiring unit 1002 of the information processing apparatus 101 may acquire the information sent from the information terminal 2202 via the network 104, without using the position information management server 102, and store the information as the detection history information 1009 in the storage unit 1008.

### <Overview>

As described above, by the information processing system 100 according to the present embodiment, it is possible to manage the detection history information 106 and the purchase history information 108 relevant to the information terminal 2202 in association with each other, based on the product identification code (example of first identification information) of the information terminal 2202.

Accordingly, even in a store, etc., without any carts 205, it is possible to analyze the consumption trends of customers with the use of the existing POS system installed in a store, etc., while suppressing capital investment.

### <General Overview>

The information processing apparatus (101) according to an embodiment of the present invention includes:

a first acquiring unit (1002) configured to acquire detection history information (1009) of a predetermined object (205 or 2202) including first identification information (1101);

a second acquiring unit (1003) configured to acquire purchase history information (1010) including the first identification information (1101) relating to the predetermined object (205 or 2202) and second identification information (1204) relating to at least one article (1018) corresponding to the predetermined object, the first identification information and the second identification information being read by a predetermined reading device (910); and

a management unit (1004) configured to manage the detection history information (1009) and the purchase history information (1010) in association with each other based on the first identification information (1101) relating to the predetermined object (205 or 2202).

Accordingly, an information processing apparatus (101) is provided, which is capable of facilitating the operation of analyzing the consumption trends of customers with the use of the existing POS system (107) installed in the store, etc., while suppressing capital investment.

The above reference numerals in parenthesis and names are given to facilitate the understanding, and are merely examples, and the scope of the present invention is not so limited.

The above embodiments are described by taking a store as an example; however, the present invention is also applicable to various facilities such as a library, a hospital, etc., other than a store.

Furthermore, the configuration of the position information management system described in the above embodiments is one example; the position information management system may acquire the detection history information by using GPS, IMES (Indoor Messaging System), etc.

According to one embodiment of the present invention, an information processing apparatus, an information processing system, and an information management method are provided, which are capable of facilitating the operation of analyzing the consumption trends of customers with the use of the existing POS system installed in the store, etc., while suppressing capital investment.

The information processing apparatus, the information processing system, and the information management method are not limited to the specific embodiments described herein, and variations and modifications may be made without departing from the spirit and scope of the present invention.

What is claimed is:

1. An information processing system comprising:
a sound wave transmitting device provided in a store, a terminal device and an information processing device,
wherein the sound wave transmitting device includes a first processor configured to:
control the sound wave transmitting device to identify itself by outputting identification information as sound wave corresponding to a location of the sound wave transmitting device within the store,
the terminal device includes a second processor configured to:
receive the identification information that is output by the sound wave transmitting device,
store the identification information along with a receiving time of the identification information,
control to display a predetermined code information based on a determination whether the terminal device receives an operation for displaying the predetermined code information corresponding to product identification information that identifies a product in the store, and
transmit, to the information processing device, identification information of a sound wave identification device and time information of receiving the identification information of the sound wave identification device along with the product identification information corresponding to a displayed predetermined code information in response to the predetermined code information being read by a predetermined reader device provided in the store,
the information processing device includes a third processor configured to:
store the identification information of the sound wave transmitting device, the time information and the product identification information received from the terminal device.

2. The information processing system according to claim 1, wherein the sound wave includes an ultrasound wave.

3. The information processing system according to claim 1, wherein the identification information of the sound wave transmitting device corresponds to information of a region where the sound wave transmitting device is arranged.

4. The information processing system according to claim 1, wherein the identification information of the sound wave transmitting device includes identification information that is stored in a memory device provided in the sound wave transmitting device or identification information that is received by the sound wave transmitting device from the information processing device through a network.

5. The information processing system according to claim 1, wherein the first processor is further configured to output the identification information by superimposing the identification information on a sound signal.

6. The information processing system according to claim 1, wherein the first processor is further configured to output the identification information in a range of frequency greater than or equal to 16 kHz.

7. The information processing system according to claim 1, wherein the product identification information includes information relating benefits that are provided to a user of the terminal device.

8. The information processing system according to claim 1, wherein the predetermined code information includes one of a barcode and a QR code.

9. An information processing method implemented by a sound wave transmitting device provided in a store, a terminal device and an information processing device,
the method comprising:
controlling, by the sound wave transmitting device, the sound wave transmitting device to identify itself by outputting identification information as sound wave corresponding to a location of the sound wave transmitting device within the store,
receiving, by the terminal device, the identification information that is output by the sound wave transmitting device,
storing, by the terminal device, the identification information along with a receiving time of the identification information,
controlling to display, by the terminal device, a predetermined code information based on a determination whether the terminal device receives an operation for displaying the predetermined code information corresponding to product identification information that identifies a product in the store, and
transmitting, by the terminal device, to the information processing device, identification information of a sound wave identification device and time information of receiving the identification information of the sound wave identification device along with the product identification information corresponding to a displayed predetermined code information in response to the predetermined code information being read by a predetermined reader device provided in the store,
storing, by the information processing device, the identification information of the sound wave transmitting device, the time information and the product identification information received from the terminal device.

10. A non-transitory computer-readable medium having computer-readable instructions recorded thereon that are executable by a terminal device of an information processing system including a sound wave transmitting device and an information processing device,
wherein the sound wave transmitting device includes a first processor configured to:
control the sound wave transmitting device to identify itself by outputting identification information as sound wave corresponding to a location of the sound wave transmitting device within the store,
wherein the computer-readable instructions causing the terminal device to implement:
receiving the identification information that is output by the sound wave transmitting device,
storing the identification information along with a receiving time of the identification information,
controlling to display a predetermined code information based on a determination whether the terminal device receives an operation for displaying the predetermined code information corresponding to product identification information that identifies a product in the store, and
transmitting to the information processing device, identification information of a sound wave identification device and time information of receiving the identification information of the sound wave identification device along with the product identification information corresponding to a displayed predetermined code information in response to the predetermined code information being read by a predetermined reader device provided in the store, and
wherein the information processing device includes a third processor configured to:
store the identification information of the sound wave transmitting device, the time information and the product identification information received from the terminal device.
